(19) United States
(12) Patent Application Publication
(10) Pub. No.: US 2025/0183770 A1
(43) Pub. Date: Jun. 5, 2025

(54) THREE-PHASE MOTOR MANUFACTURING METHOD AND THREE-PHASE MOTOR

(71) Applicant: FUJITSU GENERAL LIMITED, Kanagawa (JP)

(72) Inventor: Tomooki HASEGAWA, Kanagawa (JP)

(73) Assignee: FUJITSU GENERAL LIMITED, Kanagawa (JP)

(21) Appl. No.: 18/844,219

(22) PCT Filed: Feb. 22, 2023
(86) PCT No.: PCT/JP2023/006342

§ 371 Date: Sep. 5, 2024

(30) Foreign Application Priority Data
Mar. 8, 2022 (JP) 2022-035129

(51) Int. Cl. H02K 15/095; H02K 3/18; H02K 3/52

(52) U.S. Cl. CPC H02K 15/095; H02K 3/18; H02K 3/521

(57) ABSTRACT

A three-phase motor manufacturing method is implemented to manufacture a three-phase motor in which a first serial connection section and a second serial connection section are connected in parallel. In the three-phase motor manufacturing method, a conducting wire is continuously guided in order to enable the formation of all of a plurality of winding portions of one of the three phases; and, in the process of forming the winding portions, when the winding portions are viewed from the inner periphery side of a yoke portion along a radial direction of the yoke portion, each winding portion constituting one serial connection section from among the first serial connection section and the second serial connection section is formed by winding the conducting wire in one direction, and each winding portion constituting the other serial connection section is formed by winding the conducting wire in the other direction.

### FIELD

The present invention relates to a three-phase motor manufacturing method, and relates to a three-phase motor.

### BACKGROUND

In a three-phase motor, the stator core includes a ring-like yoke portion and a plurality of teeth portions protruding from the yoke portion toward the inside in a radial direction of the yoke portion. Around each teeth portion, a conducting wire is wound to form a winding portion. In a three-phase motor of the abovementioned type, a plurality of winding portions of each phase has one end thereof connected to neutral points according to a star connection. Regarding such a star connection, serial wiring and parallel wiring is known (refer to Patent Literature 1).

In the serial wiring, the combined resistance of a plurality of serially-connected winding portions in a single phase is equal to the sum of the resistances of the winding portions. Hence, in order to hold down the power dissipation by lowering the resistance value of each of the serially-connected winding portions, a conducting wire having a large wire diameter, is used. On the other hand, in the parallel wiring, the combined resistance of a plurality of parallelly-connected winding portions is lower as compared to the combined resistance in the serial wiring. Hence, it becomes possible to use a conducting wire having a small wire diameter. However, in order to connect the winding portions in parallel; after the winding portions are formed, the conducting wire needs to be cut at each connection point and then the winding portions need to be joined in parallel. As a result, the wiring process becomes complex.

### CITATION LIST

### Patent Literature

[Patent Literature 1] Japanese Patent No. 5741747

### SUMMARY

### Technical Problem

Regarding a three-phase motor including 12 or more winding portions, as a wiring method in which the advantages of the serial wiring as well as the parallel wiring are utilized, a type of wiring is being considered in which a first serial connection section and a second serial connection section that have a plurality of winding portions serially connected therein, are connected in parallel. (hereinafter, called a serial-parallel wiring). In the serial-parallel wiring, not only the wire diameter of the conducting wire can be reduced to be smaller than the wire diameter in the serial wiring, but the wiring process can also be shortened as compared to the wiring process in the parallel wiring.

As an example, in what is called a 12-slot three-phase motor that includes 12 winding portions, each phase has four winding portions. In the case of performing serial-parallel wiring of four winding portions of a single phase, for example, it is possible to think of the following: a conducting wire is wound in a particular direction so that two winding portions are sequentially formed from the power source side toward the neutral point side. After that, the conducting wire is cut once so that form a neutral point is formed, and then the conducting wire is wound in the same direction in an identical manner so that two more winding portions are sequentially formed from the power source side toward the neutral point side. However, in such a winding process for forming the winding portions, since the conducting wire is cut once during the winding operation meant for forming the winding portions of a single phase, the winding operation in which a nozzle is used to supply the conducting wire, still remains complex.

The technology disclosed herein is developed in view of the issues explained above, and it is an objective to provide a three-phase motor manufacturing method by which all winding portions of a single phase can be formed without having to cut the conducting wire during the winding operation, so that the productivity of the three-phase motor can be enhanced; and to provide a three-phase motor having an enhanced productivity.

### Solution to Problem

According to an aspect of an embodiments in the present application, a three-phase motor manufacturing method for manufacturing a three-phase motor that includes: a stator core which includes a ring-like yoke portion, and a plurality of teeth portions that protrudes from the yoke portion toward inside in a radial direction of the yoke portion, and a plurality of winding portions each of which is formed by winding a conducting wire to one of the teeth portions of the stator core, the winding portions of each phase, from among three phases, includes a first serial connection section in which two or more of the winding portions are serially connected, and a second serial connection section in which two or more of the winding portions are serially connected, and the first serial connection section and the second serial connection section being connected in parallel, the three-phase motor manufacturing method comprising forming that includes continuously guiding the conducting wire, and forming all of the plurality of winding portions of one phase from among the three phases, wherein when winding portions are viewed from inner periphery side of the yoke portion along a radial direction of the yoke portion, the forming of the winding portions includes winding the conducting wire in one direction and forming the winding portions included in one serial connection section from among the first serial connection section and the second serial connection section, and winding the conducting wire in other direction and forming the winding portions included in other serial connection section from among the first serial connection section and the second serial connection section.

### Advantageous Effects of Invention

According to an aspect of the three-phase motor manufacturing method disclosed in the application concerned, all winding portions of a single phase can be formed without having to cut the conducting wire during the winding operation, so that the productivity of the three-phase motor can be enhanced.

### BRIEF DESCRIPTION OF DRAWINGS

FIG. 1 is a vertical cross-sectional view of a rotary compressor that includes a three-phase motor according to a first embodiment;

FIG. 2 is a planar view of the three-phase motor according to the first embodiment;

FIG. 3 is a lower view of a stator core included in the three-phase motor according to the first embodiment;

FIG. 4 is a lower view of a stator on which winding portions are formed in the three-phase motor according to the first embodiment;

FIG. 5 is a connection wiring diagram illustrating the wiring state of the winding portions of each phase according to the first embodiment;

FIG. 6 is a development diagram for explaining the stretch path of the winding wire that constitutes the winding portions of a U phase according to the first embodiment;

FIG. 7 is a development diagram for explaining the stretch paths of the winding wires that constitute the winding portions of three phases according to the first embodiment;

FIG. 8 is a perspective view of a splice terminal that constitutes a first neutral point and a second neutral point in the three-phase motor according to the first embodiment;

FIG. 9 is a connection wiring diagram illustrating the wiring state of the winding portions of each phase according to a second embodiment;

FIG. 10 is a development diagram for explaining the stretch path of the winding wire that constitutes the winding portions of the U phase according to the second embodiment;

FIG. 11 is a development diagram for explaining the stretch paths of the winding wires that constitute the winding portions of the three phases according to the second embodiment;

FIG. 12 is a development diagram for explaining a modification example of the stretch path of the winding wires according to the second embodiment;

FIG. 13 is a connection wiring diagram illustrating the wiring state of the winding portions of each phase according to a third embodiment;

FIG. 14 is a development diagram for explaining the stretch path of the winding wire that constitutes the winding portions of the U phase according to the third embodiment;

FIG. 15 is a development diagram for explaining the stretch paths of the winding wires that constitute the winding portions of the three phases according to the third embodiment; and

FIG. 16 is a connection wiring diagram illustrating the wiring state of the winding portions in the case in which only a single neutral point is present according to a modification example.

### DESCRIPTION OF EMBODIMENTS

Exemplary embodiments of a three-phase motor manufacturing method and a three-phase motor disclosed in the application concerned are described in detail with reference to the accompanying drawings. However, the three-phase motor manufacturing method and the three-phase motor disclosed in the application concerned, are not limited by the embodiments described below.

### First Embodiment

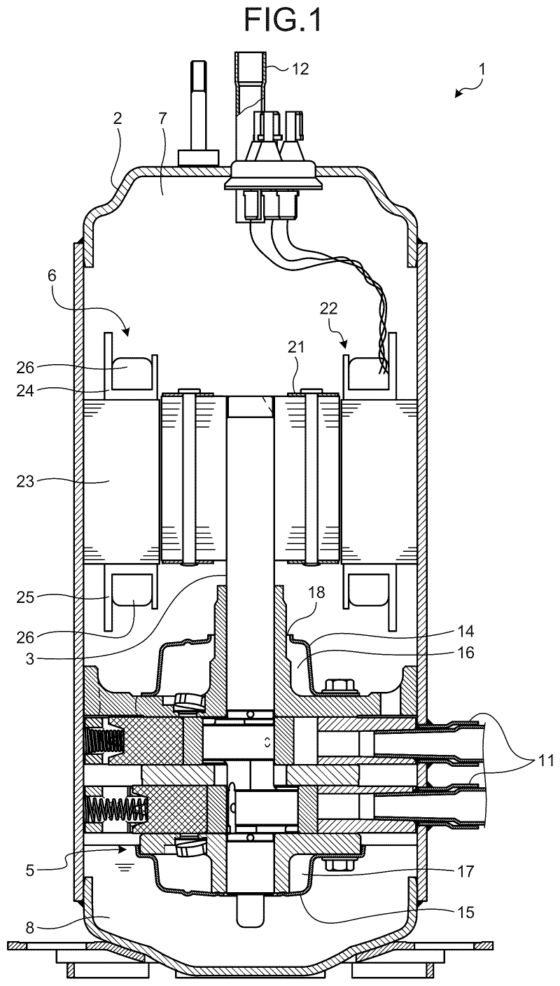

Firstly, the explanation is given about a rotary compressor that includes a freezing cycle device, and about a three-phase motor used in the rotary compressor. FIG. 1 is a vertical cross-sectional view of a rotary compressor that includes a three-phase motor according to a first embodiment.

As illustrated in FIG. 1, a compressor 1 is, what is called, a rotary compressor that includes a container 2, a rotary shaft 3, a compressing section 5, and a three-phase motor 6. The container 2 is made of a metallic material and constitutes a sealed internal space 7 that is roughly cylindrical in shape. When the container 2 is placed vertically on a horizontal plane, the central axis of the internal space 7 remains parallel to the vertical direction. In the container 2, an oil sump 8 is formed in the lower part of the internal space 7. The oil sump 8 is used to accumulate a refrigeration machine oil that represents a lubricant oil meant for lubricating the compressing section 5. To the container 2, a suction pipe 11 is connected through which a refrigerant is sucked in, and a discharge pipe 12 is connected through which the compressed refrigerant is discharged. The rotary shaft 3 is disposed along the vertical direction and is placed inside the internal space 7 of the container 2 in such a way that one end of the rotary shaft 3 remains immersed in the oil sump 8. The rotary shaft 3 is supported by the container 2 in a rotatable manner around the central axis of the internal space 7. When the rotary shaft 3 rotates, the refrigeration machine oil accumulated in the oil sump 8 is supplied to the compressing section 5.

The compressing section 5 is placed in the lower part of the internal space 7 and is placed above the oil sump 8. Meanwhile, the compressor 1 further includes an upper muffler cover 14 and a lower muffler cover 15. The upper muffler cover 14 is disposed in the upper part of the compressing section 5 in the internal space 7. Inside the upper muffler cover 14, an upper muffler chamber 16 is formed. The lower muffler cover 15 is placed in the lower part of the compressing section 5 in the internal space 7, and is placed above the oil sump 8. Inside the lower muffler cover 15, a lower muffler chamber 17 is formed. The lower muffler chamber 17 is communicated with the upper muffler chamber 16 via a communication channel (not illustrated) provided in the compressing section 5. In between the upper muffler cover 14 and the rotary shaft 3, a compressed-refrigerant discharge hole 18 is formed; and the upper muffler chamber 16 is communicated with the internal space 7 via the compressed-refrigerant discharge hole 18.

When the rotary shaft 3 rotates, the compressing section 5 compresses the refrigerant that is supplied through the suction pipe 11, and supplies the compressed refrigerant to the upper muffler chamber 16 and the lower muffler chamber 17. Herein, the refrigerant has compatibility with the refrigeration machine oil. The three-phase motor 6 is placed in the upper part of the compressing section 5 inside the internal space 7.

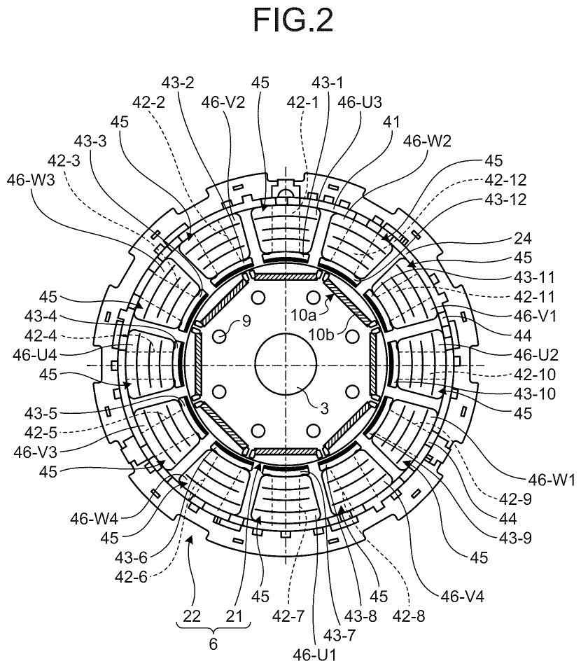

FIG. 2 is a planar view of the three-phase motor according to the first embodiment when viewed from the side of an upper insulator. As illustrated in FIGS. 1 and 2, the three-phase motor 6 includes a rotor 21 and a stator 22. The rotor 21 is formed in a cylindrical shape by laminating a plurality of thin sheets of silicon steel (a magnetic substance) integrated by a plurality of rivets 9. The rotary shaft 3 is inserted through the center of the rotor 21, and the rotor 21 is fixed to the rotary shaft 3. In the rotor 21, eight slit-like magnet embedment holes 10a are formed to constitute the sides of an octagon centered around the rotary shaft 3. The magnet embedment holes 10a are formed at regular intervals in the circumferential direction of the rotor 21. In each magnet embedment hole 10a, a plate-like permanent magnet 10b is embedded.

The stator 22 is formed to have a roughly cylindrical shape, is disposed to enclose the rotor 21, and is fixed to the container 2. The stator 22 includes a stator core 23, an upper insulator 24, a lower insulator 25, and a plurality of winding wires 46 representing conducting wires. The upper insulator 24 is fixed to the upper end portion in the axial direction of the stator core 23 (the axial direction of the rotary shaft 3). The lower insulator 25 is fixed to the lower end portion in the axial direction of the stator core 23. The upper insulator 24 and the lower insulator 25 represent examples of an insulating portion used in insulating the stator core 23 from the winding wires (conducting wires) 46.

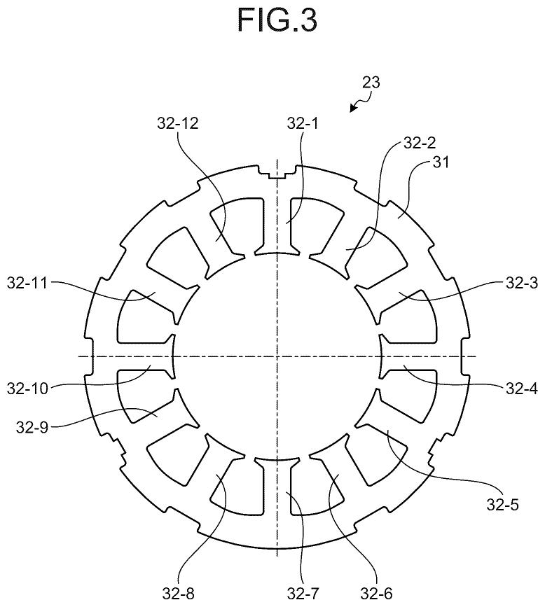

FIG. 3 is a lower view of the stator core 23 included in the three-phase motor 6 according to the first embodiment. The stator core 23 is formed, for example, by laminating a plurality of plates made of a soft magnetic substance exemplified by silicon steel plates. As illustrated in FIG. 3, the stator core 23 includes a yoke portion 31 and a plurality of stator core teeth portions 32-1 to 32-12. The yoke portion 31 is formed to have a roughly cylindrical shape. From among the stator core teeth portions 32-1 to 32-12, the first stator core teeth portion 32-1 is formed to have a roughly columnar shape. The first stator core teeth portion 32-1 is formed with one end thereof being continuous with the inner periphery of the yoke portion 31, that is, is formed to protrude from the inner periphery of the yoke portion 31. From among the stator core teeth portions 32-1 to 32-12, the other stator. core teeth portions other than the first stator core teeth portion 32-1 too are formed to have a roughly columnar shape and protrude from the inner periphery of the yoke portion 31 in an identical manner to the first stator core teeth portion 32-1. Moreover, in the case in which the stator 22 has 12 slots, the stator core teeth portions 32-1 to 32-12 are equidistantly placed at the angles of 30° on the inner periphery of the yoke portion 31.

The upper insulator 24 is formed to have a cylindrical shape and is made of an insulating substance exemplified by polybutylene terephthalate (PBT). As illustrated in FIG. 2, the upper insulator 24 includes an external wall 41, a plurality of insulator teeth portions 42-1 to 42-12 around which the winding wires (conducting wires) 46 are wound, and a plurality of flange portions 43-1 to 43-12. The external wall 41 is formed to have a roughly cylindrical shape. On the external wall 41, at intervals in the circumferential direction of the external wall 41, a plurality of slits 44 is formed to extend from one end in the direction of the central axis of the external wall 41 (i.e., from one end in the axial direction of the rotary shaft 3) along the central axis. The other end in the direction of the central axis of the external wall 41 abuts against the stator core 23. In other words, the slits 44 extend from one end on the opposite side of the stator core 23 (i.e., from the non-leading side) on the external wall 41 toward the side of the stator core 23 (i.e., toward the leading side). The winding wires 46, which are drawn out from winding portions 45 (explained later), are passed through the slits 44. With that, the winding wires 46, which are drawn from the inner periphery side of the external wall 41 toward the outer periphery side, are stretched along the outer periphery of the external wall 41.

From among the insulator teeth portions 42-1 to 42-12, the first insulator teeth portion 42-1 is formed to have the cross-sectional surface in a vertical columnar shape that is roughly semicircular. The first insulator teeth portion 42-1 is formed with one end thereof being continuous with the inner periphery of the external wall 41, that is, is formed to protrude from the inner periphery of the external wall 41. From among the insulator teeth portions 42-1 to 42-12, the other insulator teeth portions other than the first insulator teeth portion 42-1 too are formed to have a vertical columnar shape and protrude from the inner periphery of the external wall 41 in an identical manner to the first insulator teeth portion 42-1. Moreover, the insulator teeth portions 42-1 to 42-12 are equidistantly placed at the angles of 30° on the inner periphery of the external wall 41.

The flange portions 43-1 to 43-12 correspond to the insulator teeth portions 42-1 to 42-12, respectively, and are formed to have a plate-like shape that is roughly semicircular. From among the flange portions 43-1 to 43-2, the first flange portion 43-1 corresponding to the first insulator teeth portion 42-1 is integrated with the first insulator teeth portion 42-1 by being continuous with the other end of the first insulator teeth portion 42-1. From among the flange portions 43-1 to 43-12, the other flange portions other than the first flange portion 43-1 too are integrated with the insulator teeth portions 42-1 to 42-12, respectively, by being continuous with the other end of the insulator teeth portions 42-1 to 42-12, respectively.

Herein, although the explanation is given about the upper insulator 24, the lower insulator 25 too is formed in an identical manner to the upper insulator 24. That is, the lower insulator 25 is formed to have a cylindrical shape and is made of an insulating substance; and includes the external wall 41, the insulator teeth portions 42-1 to 42-12, and the flange portions 43-1 to 43-12.

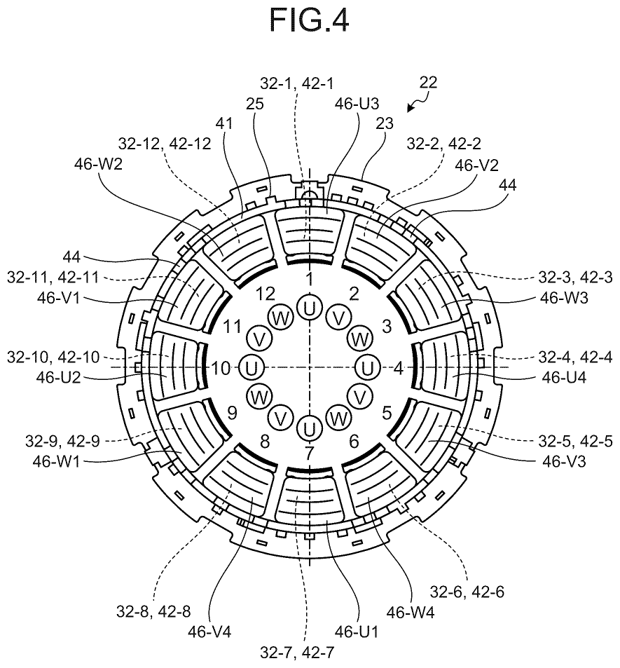

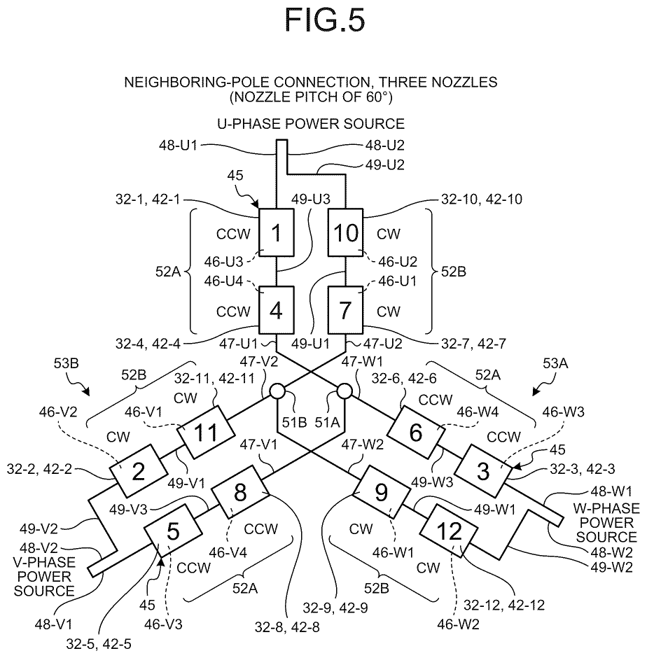

FIG. 4 is a lower view of the stator 22 according to the first embodiment. As illustrated in FIG. 4, each of the stator core teeth portions 32-1 to 32-9 of the stator core 23 has one of the winding wires 46 wound around it. As illustrated in FIG. 5 (explained later), in each of the stator core teeth portions 32-1 to 32-12, the winding portions 45 are formed due to the winding wires (conducting wires) 46 of different phases. With reference to FIG. 4, the winding portions 45 representing 12 slots are sequentially assigned with numbers 1 to 12 in the clockwise direction. The 12 winding portions 45 are arranged along the circumferential direction of the stator core 23 in such a way that the three phases are repeated in the same order, that is, the U phase, the V phase, and the W phase are repeated in that particular order in the clockwise direction in FIG. 4.

The three-phase motor 6 according to the first embodiment is a concentrated winding motor having eight electrodes and 12 slots (see FIG. 2). The winding wires (conducting wires) 46 include: a plurality of U-phase winding wires 46-U1 to 46-U4 constituting U-phase winding portions 45; a plurality of V-phase winding wires 46-V1 to 46-V4 constituting V-phase winding portions 45; and a plurality of W-phase winding wires 46-W1 to 46-W4 constituting W-phase winding portions 45.

Meanwhile, the three-phase motor according to the present invention is not limited to include 12 slots. Thus, as long as the number of slots, that is, the number of winding portions 45 is equal to or greater than 12 and is a multiple of 3, it serves the purpose. In other words, as long as the number of insulator teeth portions 42 of the upper insulator 24 (the lower insulator 25) is equal to or greater than 12 and is a multiple of 3, it serves the purpose.

### (Wiring Structure of Winding Portions of Three Phases)

FIG. 5 is a connection wiring diagram illustrating the wiring state of the winding portions 45 of each phase according to the first embodiment. With reference to FIG. 5, the winding portion 45 representing the 12 slots are assigned with reference numerals [1] to that are referred to in FIG. 5 and FIGS. 6 and 7 (explained later).

As illustrated in FIG. 5, in each phase from among the U phase, the V phase, and the W phase in the three-phase motor 6 according to the first embodiment, the winding portions 45 constitute a first serial connection section 52A in which two or more winding portions 45 are serially connected and a second serial connection section 52B in which two or more winding portions 45 are serially connected; and the first serial connection section 52A and the second serial connection section 52B are connected in parallel to each other.

In the first embodiment, when the winding portions 45 are viewed from the inner periphery side of the yoke portion 31 along a radial direction of the yoke portion 31, each winding portion 45 constituting either the first serial connection section 52A or the second serial connection section 52B is formed by winding the winding wire (conducting wire) 46 in one direction. For example, in the first serial connection section 52A, each winding portion 45 is formed by winding the winding wire (conducting wire) 46 in the counterclockwise (CCW) direction. On the other hand, when the winding portions 45 are viewed from the inner periphery side of the yoke portion 31 along a radial direction of the yoke portion 31, each winding portion 45 constituting the other serial connection section from among the first serial connection section 52A and the second serial connection section 52B is formed by winding the winding wire (conducting wire) 46 in the other direction. For example, in the second serial connection section 52B, each winding portion 45 is formed by winding the winding wire (conducting wire) 46 in the clockwise (CW) direction.

The three-phase motor 6 according to the first embodiment includes a first star connection body 53A and a second star connection body 53B, each of which includes 3M number of winding portions 45 where M represents an integer equal to or greater than 2. With reference to FIG. 5, the first star connection body 53A according to the first embodiment includes six winding portions 45, namely, the first winding portion [1] and the fourth winding portion [4], the fifth winding portion [5] and the eighth winding portion [8], and the third winding portion [3] and the sixth winding portion [6], to which a first U-phase neutral wire 47-U1 (explained later), a first V-phase neutral wire 47-V1 (explained later), and a first W-phase neutral wire 47-W1 (explained later) are electrically connected via a first neutral point 51A. Moreover, with reference to FIG. 5, the second star connection body 53B includes six winding portions 45, namely, the 10-th winding portion [10] and the seventh winding portion [7], the second winding portion [2] and the 11-th winding portion [11], and the 12-th winding portion [12] and the ninth winding portion [9], to which a second U-phase neutral wire 47-U2 (explained later), a second V-phase neutral wire 47-V2 (explained later), and a second W-phase neutral wire 47-W2 (explained later) are electrically connected via a second neutral point 51B.

Thus, as illustrated in FIG. 5, the stator 22 that includes the first star connection body 53A and the second star connection body 53B also includes two neutral points 51, namely, the first neutral point 51A and the second neutral point 51B. In the first embodiment, the first serial connection section 52A of each of the three phases is connected to the first neutral point 51A from among the two neutral points 51, and the second serial connection section 52B of each of the three phases is connected to the second neutral point 51B.

According to the first embodiment, in the three-phase motor manufacturing process for manufacturing the three-phase motor 6, a winding machine (not illustrated) is used that: supplies the winding wires 46 from a nozzle; winds the winding wires 46 across the stator core teeth portions 32-1 to 32-12 of the stator core 23 and the insulator teeth portions 42-1 to 42-12 of the lower insulator 25; and wraps the winding wires 46 along the external wall 41 of the lower insulator 25. In the first embodiment, at the time of using a winding machine and forming the winding portions 45 of the three phases, a method is implemented in which the winding portions 45 of the three phases are formed using three nozzles which perform a synchronized movement, so that the winding wires 46 of the three phases are wound in a simultaneous manner (hereinafter, the method is called three-nozzle winding).

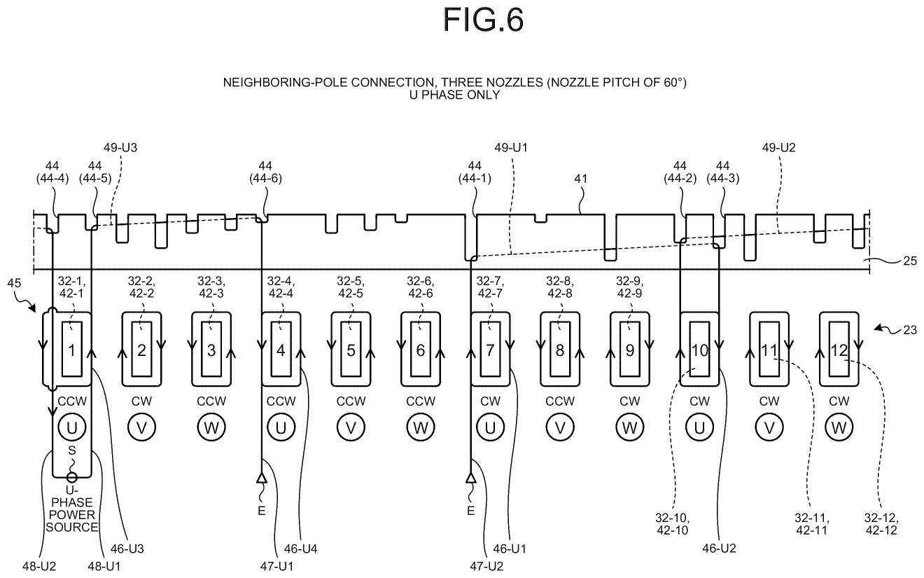

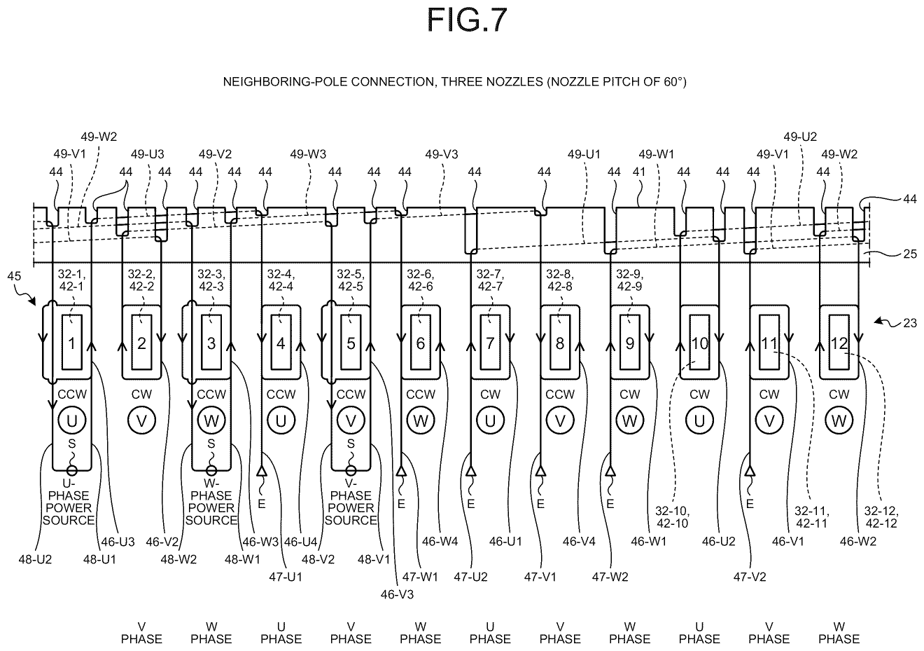

FIG. 6 is a development diagram for explaining the stretch path of the winding wire 46 that constitutes the winding portions 45 of the U phase according to the first embodiment. FIG. 7 is a development diagram for explaining the stretch paths of the winding wires 46 that constitute the winding portions 45 of the three phases according to the first embodiment. FIG. 7 is a development diagram illustrating the winding wires 46 of each phase that are wound around the lower insulator 25 and the stator core 23 according to the three-nozzle winding using three nozzles disposed at angles of 60° as the distance between the neighboring nozzles (hereinafter, called the nozzle pitch). FIGS. 6 and 7 are development diagrams for the case in which the stator core teeth portions 32 (or the insulator teeth portions 42) are viewed from the inner periphery side of the yoke portion 31 of the stator core 23 along a radial direction of the yoke portion 31 (in a radial direction of the external wall 41 of the lower insulator 25).

In FIGS. 6 and 7, the lower part represents the leading side on which power wires (leads) are placed for connection with the winding wires 46, and thus represents the side of the stator 22. Moreover, in FIGS. 6 and 7, the upper part represents the non-leading side that is the opposite side of the leading side, and thus represents the side opposite to the stator 22. Furthermore, in FIGS. 6 and 7, the winding portions 45 representing the 12 slots are assigned with reference numerals [1] to [12] and are referred to as a first winding portion to a 12-th winding portion in a sequential manner in one direction in the circumferential direction of the yoke portion 31 of the stator core 23, that is, in a sequential manner from the left end toward the right end in the drawings. Of each such winding wire 46 which is connected to a power source (not illustrated) disposed outside of the compressor 1, a start node S is illustrated as a solid circle and an end node E is illustrated as a triangle. Herein, the start node S and the end node E indicate the direction of flow of the electrical current. Thus, the electrical current flows from the start node S toward the end node E.

The wiring structure of the winding portions 45 according to the first embodiment is such that, in the arrangement in which the winding portions 45 of each phase are repeated in the order of the U phase, the V phase, and the W phase in the circumferential direction of the stator core 23, the neighboring winding portions 45 of the same phase in the arrangement direction of that phase are wired together, that is, the neighboring poles in the arrangement direction (the circumferential direction) are connected together (hereinafter, referred to as neighboring-pole connection). For example, in the U-phase winding wires 46, the first winding portion [1] that is wound around the first stator core teeth portion 32-1 is wired to the fourth winding portion [4] that is wound around the fourth stator core teeth portion 32-4, and the seventh winding portion [7] that is wound around the seventh stator core teeth portion 32-7 is wired to the 10-th winding portion [10] that is wound around the 10-th stator core teeth portion 32-10.

As illustrated in FIG. 6, the first U-phase winding wire 46-U1 that is extended from the end node E connected to the second neutral point 51B is wound around the seventh stator core teeth portion 32-7 in the clockwise (CW) direction. Then, the first U-phase winding wire 46-U1 that is drawn from the seventh winding portion [7] of the seventh stator core teeth portion 32-7 is stretched from the inner periphery side of the external wall 41 of the lower insulator 25 along the outer periphery of the external wall 41 through the corresponding slit 44. As a result, a first U-phase crossover portion 49-U1 is formed. Herein, the crossover portions 49 (crossovers) represent the portions that are drawn to the outer periphery side of the lower insulator 25 through the slits 44. Subsequently, the second U-phase winding wire 46-U2 that is drawn from the first U-phase crossover portion 49-U1 to the inner periphery side of the external wall 41 through the corresponding slit 44 is wound around the 10-th stator core teeth portion 32-10 in the clockwise direction (CW).

The second U-phase winding wire 46-2 that is drawn from the 10-th winding portion [10] of the 10-th stator core teeth portion 32-10 is stretched from the inner periphery side of the external wall 41 of the lower insulator 25 along the outer periphery of the external wall 41 through the corresponding slit 44. As a result, a second U-phase crossover portion 49-U2 is formed. The third U-phase winding wire 46-U3 that is drawn from the second U-phase crossover portion 49-U2 to the inner periphery side of the external wall 41 through the corresponding slit 44 is extended as the start node S to be connected to the U-phase power source and, without being cut at the start node S, is continuously extended and wound around the first stator core teeth portion 32-1 in the counterclockwise (CCW) direction.

The third U-phase winding wire 46-U3 that is drawn from the first winding portion [1] of the first stator core teeth portion 32-1 is stretched from the inner periphery side of the external wall 41 of the lower insulator 25 along the outer periphery of the external wall 41 through the corresponding slit 44. As a result, a third U-phase crossover portion 49-U3 is formed. Then, the fourth U-phase winding wire 46-U4 that is drawn from the third U-phase crossover portion 49-U3 to the inner periphery side of the external wall 41 through the corresponding slit 44 is wound around the fourth stator core teeth portion 32-4 in the counterclockwise (CCW) direction. The fourth U-phase winding wire 46-U4 that is drawn from the fourth winding portion [4] of the fourth stator core teeth portion 32-4 is extended up to the end node E that is connected to the first neutral point 51A.

In this way, in the seventh stator core teeth portion 32-7, the 10-th stator core teeth portion 32-10, the first stator core teeth portion 32-1, and the fourth stator core teeth portion 32-4 in that order; the U-phase winding wires 46 constitute the winding portions 45 in a continuous manner without getting cut midway. In the third U-phase winding wire 46-U3, the portion that is extended as the start node S to be connected to the U-phase power source is cut into two start nodes S in a subsequent process to the process of forming the U-phase winding portions 45 as explained above, and the two start nodes S are used as a first U-phase power wire 48-U1 (explained later) and a second U-phase power wire 48-U2 (explained later) and are connected to the U-phase power source.

Meanwhile, in the first embodiment, the U-phase winding wires 46 are wound in such a way that the U-phase winding portions 45 are formed in the seventh winding portion [7], the 10-th winding portion [10], the first winding portion [1], and the fourth winding portion [4] in that order. However, instead of starting the winding from the seventh winding portion [7], if the positions referred to as the first winding portion [1] to the 12-th winding portion [12] are shifted in such a way that the winding is started at the first winding portion [1] (i.e., in the first embodiment, if the seventh winding portion [7] is referred to as the first winding portion [1]), then the structure can be rephrased as the structure in which the winding is done in the first winding portion [1], the fourth winding portion [4], the seventh winding portion [7], and the 10-th winding portion [10] in that order. The same order of winding is applicable in the V phase and the W phase too.

In the following explanation, the order of winding the U-phase winding wires 46 is rephrased in terms of the order of the slits 44 on the external wall 41 of the lower insulator 25 through which the U-phase winding wires 46 are passed. As illustrated in FIG. 6, the slit 44 that represents the first U-phase crossover portion 49-U1 through which the first U-phase winding wire 46-U1, which is drawn from the seventh winding portion [7], is passed is referred to as a first slit 44-1. Assume that the slits 44 through which the U-phase winding wires 46 are passed are referred to as the first slit 44-1, a second slit 44-2, a third slit 44-3, a fourth slit 44-4, a fifth slit 44-5, and a sixth slit 44-6 in that order of arrangement toward one side of the circumferential direction of the external wall 41 of the lower insulator 25, that is, toward the right side in FIG. 6. In that case, when the U-phase winding wires 46 are wound to form the seventh winding portion [7], the 10-th winding portion [10], the first winding portion [1], and the fourth winding portion [4] in that order; the U-phase winding wires 46 are passed through the first slit 44-1, the third slit 44-3, the second slit 44-2, the fourth slit 44-4, the fifth slit 44-5, and the sixth slit 44-6 in that order. In the V phase and the W phase too, the passage of the corresponding winding wires 46 through the first slit 44-1 to the sixth slit 44-6 occurs in the abovementioned order.

Moreover, regarding the U-phase winding wires 46, in the circumferential direction of the stator 22, the orientation of the electrical current flowing from the start node S, which is connected to the U-phase power source, toward the end node E via the first winding portion [1] and the fourth winding portion [4] in that order is opposite to the orientation of the electrical current flowing from the start node S toward the end node E via the 10-th winding portion [10] and the seventh winding portion [7] in that order. Hence, in order to match the direction in which the magnetic flux is generated in the four winding portions 45, the U-phase winding wires 46 are wound in the clockwise (CW) direction around the seventh stator core teeth portion 32-7 and the 10-th stator core teeth portion 32-10 but are wound in the counterclockwise (CCW) direction around the first stator core teeth portion 32-1 and the fourth stator core teeth portion 32-4. In other words, from among the U-phase winding portions 45, the winding portions 45 included in the second serial connection section 52B of the two serial connection sections 52 (i.e., the seventh winding portion [7] and the 10-th winding portion [10]) are formed by winding the winding wires 46 in the clockwise (CW) direction; and the winding portions 45 included in the first serial connection section 52A of the two serial connection sections 52 (i.e., the first winding portion [1] and the fourth winding portion [4]) are formed by winding the winding wires 46 in the counterclockwise (CCW) direction.

Regarding the order of the slits 44 through which the U-phase winding wires 46 are passed, the two slits 44 through which the U-phase winding wires 46 are passed before and after the formation of the first winding portion [1] (i.e., the fourth slit 44-4 and the fifth slit 44-5) are referred to as a first slit pair for descriptive purposes. Moreover, the two slits 44 through which the U-phase winding wires 46 are passed before and after the formation of the 10-th winding portion [10] (i.e., the third slit 44-3 and the second slit 44-2) are referred to as a second slit pair. At that time, the order in which the two slits 44 constituting the first slit pair (i.e., the fourth slit 44-4 and the fifth slit 44-5) are arranged toward one side of the circumferential direction of the external wall 41 matches with the order in which the winding wires 46 pass through those two slits 44 at the time of winding. On the other hand, the order in which the two slits 44 constituting the second slit pair (i.e., the third slit 44-3 and the second slit 44-2) are arranged toward one side of the circumferential direction of the external wall 41 is opposite to the order in which the winding wires 46 pass through those two slits 44 at the time of winding. As a result, even when the winding orientation of the winding wires 46 is reversed midway between the clockwise (CW) direction and the counterclockwise (CCW) direction, that portion of the winding wire 46 which extends from the slits 44 up to the winding portions 45 can be extended parallel to the axial direction of the rotary shaft 3, thereby enabling achieving reduction in the load exerted on that portion of the winding wires 46 which is hooked in the slits 44. The same is the case regarding the V phase and the W phase.

As illustrated in FIG. 7, the first V-phase winding wire 46-V1 that is extended from the end node E connected to the second neutral point 51B is wound around the 11-th stator core teeth portion 32-11 in the clockwise (CW) direction. Then, the first V-phase winding wire 46-V1 that is drawn from the 11-th winding portion [11] of the 11-th stator core teeth portion 32-11 is stretched from the inner periphery side of the external wall 41 of the lower insulator 25 along the outer periphery of the external wall 41 of the corresponding slit 44. As a result, a first V-phase crossover portion 49-V1 is formed. The second V-phase winding wire 46-V2 that is drawn from the first V-phase crossover portion 49-V1 to the inner periphery side of the external wall 41 through the corresponding slit 44 is wound around the second stator core teeth portion 32-2 in the clockwise (CW) direction.

Then, the second V-phase winding wire 46-V2 that is drawn from the second winding portion [2] of the second stator core teeth portion 32-2 is stretched from the inner periphery side of the external wall 41 of the lower insulator 25 along the outer periphery of the external wall 41 through the corresponding slit 44. As a result, a second V-phase crossover portion 49-V2 is formed. The third V-phase winding wire 46-V3 that is drawn from the second V-phase crossover portion 49-V2 to the inner periphery side of the external wall 41 through the corresponding slit 44 is extended as the start node S to be connected to the V-phase power source and, without being cut at the start node S, is continuously extended and wound around the fifth stator core teeth portion 32-5 in the counterclockwise (CCW) direction.

The third V-phase winding wire 46-V3 that is drawn from the fifth winding portion [5] of the fifth stator core teeth portion 32-5 is stretched from the inner periphery side of the external wall 41 of the lower insulator 25 along the outer periphery of the external wall 41 through the corresponding slit 44. As a result, a third V-phase crossover portion 49-V3 is formed. The fourth V-phase winding wire 46-V4 that is drawn from the third V-phase crossover portion 49-V3 to the inner periphery side of the external wall 41 through the corresponding slit 44 is wound around the eighth stator core teeth portion 32-8 in the counterclockwise (CCW) direction. The fourth V-phase winding wire 46-V4 that is drawn from the eighth winding portion [8] of the eighth stator core teeth portion 32-8 is extended up to the end node E that is to be connected to the first neutral point 51A.

In this way, in the 11-th stator core teeth portion 32-11, the second stator core teeth portion 32-2, the fifth stator core teeth portion 32-5, and the eighth stator core teeth portion 32-8 in that order; the V-phase winding wires 46 constitute the winding portions 45 in a continuous manner without getting cut midway. In the third V-phase winding wire 46-V3, the portion that is extended as the start node S to be connected to the V-phase power source is cut into two start nodes S in a subsequent process to the process of forming the V-phase winding portions 45 as explained above, and the two start nodes S are used as a first V-phase power wire 48-V1 (explained later) and a second V-phase power wire 48-V2 (explained later) and are connected to the V-phase power source.

Moreover, regarding the V-phase winding wires 46, in the circumferential direction of the stator 22, the orientation of the electrical current flowing from the start node S, which is connected to the V-phase power source, toward the end node E via the fifth winding portion [5] and the eighth winding portion [8] in that order is opposite to the orientation of the electrical current flowing from the start node S toward the end node E via the second winding portion [2] and the 11-th winding portion [11] in that order. Hence, in order to match the direction in which the magnetic flux is generated in the four winding portions 45, the V-phase winding wires 46 are wound in the clockwise (CW) direction around the 11-th stator core teeth portion 32-11 and the second stator core teeth portion 32-2 but are wound in the counterclockwise (CCW) direction around the fifth stator core teeth portion 32-5 and the eighth stator core teeth portion 32-8. In other words, from among the V-phase winding portions 45, the winding portions 45 included in the second serial connection section 52B of the two serial connection sections 52 (i.e., the 11-th winding portion [11] and the second winding portion [2]) are formed by winding the winding wires 46 in the clockwise (CW) direction; and the winding portions 45 included in the first serial connection section 52A of the two serial connection sections 52 (i.e., the fifth winding portion [5] and the eighth winding portion [8]) are formed by winding the winding wires 46 in the counterclockwise (CCW) direction.

As illustrated in FIG. 7, the first W-phase winding wire 46-W1 that is extended from the end node E connected to the second neutral point 51B is wound around the ninth stator core teeth portion 32-9 in the clockwise (CW) direction. Then, the first W-phase winding wire 46-W1 that is drawn from the ninth winding portion [9] of the ninth stator core teeth portion 32-9 is stretched from the inner periphery side of the external wall 41 of the lower insulator 25 along the outer periphery of the external wall 41 of the corresponding slit 44. As a result, a first W-phase crossover portion 49-W1 is formed. The second W-phase winding wire 46-W2 that is drawn from the first W-phase crossover portion 49-W1 to the inner periphery side of the external wall 41 through the corresponding slit 44 is wound around the 12-th stator core teeth portion 32-12 in the clockwise (CW) direction.

Then, the second W-phase winding wire 46-W2 that is drawn from the 12-th winding portion [12] of the 12-th stator core teeth portion 32-12 is stretched from the inner periphery side of the external wall 41 of the lower insulator 25 along the outer periphery of the external wall 41 through the corresponding slit 44. As a result, a second W-phase crossover portion 49-W2 is formed. The third W-phase winding wire 46-W3 that is drawn from the second W-phase crossover portion 49-W2 to the inner periphery side of the external wall 41 through the corresponding slit 44 is extended as the start node S to be connected to the W-phase power source and, without being cut at the start node S, is continuously extended and wound around the third stator core teeth portion 32-3 in the counterclockwise (CCW) direction.

The third W-phase winding wire 46-W3 that is drawn from the third winding portion [3] of the third stator core teeth portion 32-3 is stretched from the inner periphery side of the external wall 41 of the lower insulator 25 along the outer periphery of the external wall 41 through the corresponding slit 44. As a result, a third W-phase crossover portion 49-W3 is formed. The fourth W-phase winding wire 46-W4 that is drawn from the third W-phase crossover portion 49-W3 to the inner periphery side of the external wall 41 through the corresponding slit 44 is wound around the sixth stator core teeth portion 32-6 in the counterclockwise (CCW) direction. Then, the fourth W-phase winding wire 46-W4 that is drawn from the sixth winding portion [6] of the sixth stator core teeth portion 32-6 is extended up to the end node E that is to be connected to the first neutral point 51A.

In this way, in the ninth stator core teeth portion 32-9, the 12-th stator core teeth portion 32-12, the third stator core teeth portion 32-3, and the sixth stator core teeth portion 32-6 in that order; the W-phase winding wires 46 constitute the winding portions 45 in a continuous manner without getting cut midway. In the third W-phase winding wire 46-W3, the portion that is extended as the start node S to be connected to the W-phase power source is cut into two start nodes S in a subsequent process to the process of forming the W-phase winding portions 45 as explained above, and the two start nodes S are used as a first W-phase power wire 48-W1 (explained later) and a second W-phase power wire 48-W2 (explained later) and are connected to the W-phase power source.

Moreover, regarding the W-phase winding wires 46, in the circumferential direction of the stator 22, the orientation of the electrical current flowing from the start node S, which is connected to the W-phase power source, toward the end node E via the third winding portion [3 ] and the sixth winding portion [6] in that order is opposite to the orientation of the electrical current flowing from the start node S toward the end node E via the 12-th winding portion [12] and the ninth winding portion [9] in that order. Hence, in order to match the direction in which the magnetic flux is generated in the four winding portions 45, the W-phase winding wires 46 are wound in the clockwise (CW) direction around the ninth stator core teeth portion 32-9 and the 12-th stator core teeth portion 32-12 but are wound in the counterclockwise (CCW) direction around the third stator core teeth portion 32-3 and the sixth stator core teeth portion 32-6. In other words, from among the W-phase winding portions 45, the winding portions 45 included in the second serial connection section 52B of the two serial connection sections 52 (i.e., the ninth winding portion [9] and the 12-th winding portion [12]) are formed by winding the winding wires 46 in the clockwise (CW) direction; and the winding portions 45 included in the first serial connection section 52A of the two serial connection sections 52 (i.e., the third winding portion [3] and the sixth winding portion [6]) are formed by winding the winding wires 46 in the counterclockwise (CCW) direction.

As illustrated in FIGS. 5 and 7, the stator 22 further includes the first U-phase neutral wire 47-U1 and the second U-phase neutral wire 47-U2, includes the first V-phase neutral wire 47-V1 and the second V-phase neutral wire 47-V2, and includes the first W-phase neutral wire 47-W1 and the second W-phase neutral wire 47-W2. The first U-phase neutral wire 47-U1 and the second U-phase neutral wire 47-U2, the first V-phase neutral wire 47-V1 and the second V-phase neutral wire 47-V2, and the first W-phase neutral wire 47-W1 and the second W-phase neutral wire 47-W2 represent those portions in the respective power wires which are on the side of the end node E.

The first U-phase neutral wire 47-U1 has one end thereof electrically connected to the fourth U-phase winding wire 46-U4 and has the other end thereof electrically connected to the first neutral point 51A. The second U-phase neutral wire 47-U2 has one end thereof electrically connected to the first U-phase winding wire 46-U1 and has the other end thereof electrically connected to the second neutral point 51B. The first V-phase neutral wire 47-V1 has one end thereof electrically connected to the fourth V-phase winding wire 46-V4 and has the other end thereof electrically connected to the first neutral point 51A. The second V-phase neutral wire 47-V2 has one end thereof electrically connected to the first V-phase winding wire 46-V1 and has the other end thereof electrically connected to the second neutral point 51B. The first W-phase neutral wire 47-W1 has one end thereof electrically connected to the fourth V-phase winding wire 46-V4 and has the other end thereof electrically connected to the first neutral point 51A. The second W-phase neutral wire 47-W2 has one end thereof electrically connected to the first V-phase winding wire 46-V1 and has the other end thereof electrically connected to the second neutral point 51B.

The stator 22 further includes the first U-phase power wire 48-U1 and the second U-phase power wire 48-U2, includes the first V-phase power wire 48-V1 and the second V-phase power wire 48-V2, and includes the first W-phase power wire 48-W1 and the second W-phase power wire 48-W2 (hereinafter, also collectively referred to as power wires 48). The first U-phase power wire 48-U1 is extended from the start node S and is connected to the first winding portion [1] of the first stator core teeth portion 32-1. The second U-phase power wire 48-U2 is extended from the start node S and is connected to the 10-th winding portion [10] of the 10-th stator core teeth portion 32-10. The first V-phase power wire 48-V1 is extended from the start node S and is connected to the fifth winding portion [5] of the fifth stator core teeth portion 32-5. The second V-phase power wire 48-V2 is extended from the start node S and is connected to the second winding portion [2] of the second stator core teeth portion 32-2. The first W-phase power wire 48-W1 is extended from the start node S and is connected to the third winding portion [3] of the third stator core teeth portion 32-3. The second V-phase power wire 48-W2 is extended from the start node S and is connected to the first winding portion [1] of the 12-th stator core teeth portion 32-12.

### (Three-Phase Motor Manufacturing Method)

In the first embodiment, as an example, the explanation is given about a winding process in which, using a winding machine that includes three nozzles whose movements are mutually synchronized, the winding wires 46 (conducting wires) are wound around the stator core 23 according to the three-nozzle winding, thereby resulting in the formation of the winding portions 45. As a result of using a winding machine in which the movements of three nozzles are synchronized, the winding wires 46 of each of the U phase, the V phase, and the W phase are simultaneously wound according to a predetermined winding method around the stator core 23 having the upper insulator 24 and the lower insulator 25 attached thereto; and one winding portion 45 of each phase, that is, a total of three winding portions 45 are simultaneously formed. Thus, in each phase, four winding portions 45 are formed as explained above, thereby making it a total of 12 winding portion 45. As a result, the stator 22 is manufactured. As the conducting wires representing the winding wires 46, for example, enameled wires (i.e., electrical wires in which copper wires are covered by enamel covering) are used.

The winding machine meant for three-nozzle winding includes a U-phase conducting wire nozzle, a V-phase conducting wire nozzle, and a W-phase conducting wire nozzle. In the winding machine meant for three-nozzle winding, a single nozzle is placed after every 60° around the central axis of the stator core 23. The winding machine meant for three-nozzle winding moves the three nozzles (the V-phase conducting wire nozzle, the W-phase conducting wire nozzle, and the U-phase conducting wire nozzle) are moved in a synchronized manner around the central axis of the stator core 23. Then, the U-phase conducting wire nozzle is moved to take a predetermined action so that the U-phase conducting wire is wound around a predetermined position of the stator core 23. At the same time, the V-phase conducting wire nozzle is moved to take a predetermined action so that the V-phase conducting wire is wound around a predetermined position of the stator core 23. Moreover, at the same time, the W-phase conducting wire nozzle is moved to take a predetermined action so that the W-phase conducting wire is wound around a predetermined position of the stator core 23.

In the winding machine, firstly, the upper insulator 24 is set; the lower insulator 25 is set; and the stator core 23 having an insulation film (not illustrated) attached thereto is set. The winding machine moves the U-phase conducting wire nozzle in such a way that one end of the U-phase winding wire 46 gets placed at the seventh stator core teeth portion 32-7 and the winding starts from the side of the end node E extended as the second U-phase neutral wire 47-U2. At the same time, the winding machine moves the V-phase conducting wire nozzle in such a way that one end of the V-phase winding wire 46 gets placed at the 11-th stator core teeth portion 32-11 and the winding starts from the side of the end node E extended as the second V-phase neutral wire 47-V2. Moreover, at the same time, the winding machine moves the W-phase conducting wire nozzle in such a way that one end of the W-phase winding wire 46 gets placed at the ninth stator core teeth portion 32-9 and the winding starts from the side of the end node E extended as the second W-phase neutral wire 47-W2.

The winding machine winds the U-phase winding wire 46, which is extended from the end node E, around the seventh stator core teeth portion 32-7 in the clockwise (CW) direction, thereby resulting in the formation of the first U-phase winding wire 46-U1 due to the U-phase winding wire 46. At that time, the winding machine moves the V-phase conducting wire nozzle in synchronization with the movement of the U-phase conducting wire nozzle and winds the V-phase winding wire 46, which is extended from the end node E, around the 11-th stator core teeth portion 32-11 in the clockwise (CW) direction, thereby resulting in the formation of the first V-phase winding wire 46-V1 due to the V-phase winding wire 46. Moreover, the winding machine moves the W-phase conducting wire nozzle in synchronization with the movement of the U-phase conducting wire nozzle and winds the W-phase winding wire 46, which is extended from the end node E, around the ninth stator core teeth portion 32-9 in the clockwise (CW) direction, thereby resulting in the formation of the first w-phase winding wire 46-W1 due to the W-phase winding wire 46.

Subsequently, the winding machine moves the U-phase conducting wire nozzle in such a way that the U-phase winding wire 46, which is extended from the first U-phase winding wire 46-U1, is passed through the corresponding slit 44 on the external wall 41; and then the U-phase winding wire 46, which is drawn from the inner periphery side of the external wall 41 toward the outer periphery side, is run along the outer periphery of the external wall 41. As a result, the first U-phase crossover portion 49-U1 is formed due to the U-phase winding wire 46. Then, the winding machine moves the U-phase conducting wire nozzle in such a way that the U-phase winding wire 46, which is extended from the first U-phase crossover portion 49-U1, is passed through the corresponding slit 44; and then the U-phase winding wire 46, which is pulled in toward the inner periphery side of the external wall 41 from the outer periphery side, is wound around the 10-th stator core teeth portion 32-10 in the clockwise (CW) direction. As a result, the second U-phase winding wire 46-U2 is formed due to the U-phase winding wire 46.

At that time, due to the V-phase winding wire 46 that is extended from the first V-phase winding wire 46-V1, the first V-phase crossover portion 49-V1 is formed. Moreover, at the same time, due to the W-phase winding wire 46 that is extended from the first W-phase winding wire 46-W1, the first W-phase crossover portion 49-W1 is formed. In an identical manner, the winding machine meant for three-nozzle winding moves the V-phase conducting wire nozzle in synchronization with the movement of the U-phase conducting wire nozzle, so that the V-phase winding wire, which is extended from the first V-phase crossover portion 49-V1, is passed through the corresponding slit 44 and is wound around the second stator core teeth portion 32-2 in the clockwise (CW) direction. As a result, the second V-phase winding wire 46-V2 is formed due to the V-phase winding wire 46. Moreover, the winding machine meant for three-nozzle winding moves the W-phase conducting wire nozzle in synchronization with the movement of the U-phase conducting wire nozzle, so that the W-phase conducting wire, which is extended from the first W-phase crossover portion 49-W1, is passed through the corresponding slit 44 and is wound around the 12-th stator core teeth portion 32-12 in the clockwise (CW) direction. As a result, the second W-phase winding wire 46-W2 is formed due to the W-phase winding wire 46.

Subsequently, the winding machine moves the U-phase conducting wire nozzle in such a way that the U-phase winding wire 46, which extends from the second U-phase winding wire 46-U2, is passed through the corresponding slit 44 on the external wall 41; and then the U-phase winding wire 46, which is drawn from the inner periphery side of the external wall 41 toward the outer periphery side, is run along the outer periphery of the external wall 41. As a result, the second U-phase crossover portion 49-U2 is formed due to the U-phase winding wire 46. Then, the winding machine moves the U-phase conducting wire nozzle in such a way that the U-phase winding wire 46, which is extended from the second U-phase crossover portion 49-U2, is passed through the corresponding slit 44; and then the U-phase winding wire 46, which is pulled in toward the inner periphery side of the external wall 41 from the outer periphery side, is extended as the first U-phase power wire 48-U1 and the second U-phase power wire 48-U2, and, without being cut at the start node S, is continuously extended and wound around the first stator core teeth portion 32-1 in the counterclockwise (CCW) direction. As a result, the third U-phase winding wire 46-U3 is formed due to the U-phase winding wire 46.

At that time, the winding machine moves the V-phase conducting wire nozzle and the W-phase conducting wire nozzle in synchronization with the movement of the U-phase conducting wire nozzle; so that the second V-phase crossover portion 49-V2 is formed due to the V-phase winding wire 46 extending from the second V-phase winding wire 46-V2 and, at the same time, the second W-phase crossover portion 49-W2 is formed due to the W-phase winding wire 46 extending from the second W-phase winding wire 46-W2. In an identical manner, the winding machine moves the V-phase conducting wire nozzle in synchronization with the movement of the U-phase conducting wire nozzle, so that the V-phase winding wire 46, which is extended from the second V-phase crossover portion 49-V2, is passed through the corresponding slit 44; and then the V-phase winding wire 46, which is pulled in toward the inner periphery side of the external wall 41 from the outer periphery side, is extended as the first V-phase power wire 48-V1 and the second V-phase power wire 48-V2, and, without being cut at the start node S, is continuously extended and wound around the fifth stator core teeth portion 32-5 in the counterclockwise (CCW) direction. As a result, the third V-phase winding wire 46-V3 is formed due to the V-phase winding wire 46. Moreover, in an identical manner, the winding machine moves the W-phase conducting wire nozzle in synchronization with the movement of the U-phase conducting wire nozzle, so that the W-phase conducting wire, which is extended from the second W-phase crossover portion 49-W2, is passed through the corresponding slit 44; and then the W-phase winding wire 46, which is pulled in toward the inner periphery side of the external wall 41 from the outer periphery side, is extended as the first W-phase power wire 48-W1 and the second W-phase power wire 48-W2, and, without being cut at the start node S, is continuously extended and wound around the third stator core teeth portion 32-3 in the counterclockwise (CCW) direction. As a result, the third W-phase winding wire 46-W3 is formed due to the W-phase winding wire 46.

Subsequently, the winding machine moves the U-phase conducting wire nozzle in such a way that the U-phase winding wire 46, which is extended from the third U-phase winding wire 46-U3, is passed through the corresponding slit 44 on the external wall 41; and then the U-phase winding wire 46, which is drawn from the inner periphery side of the external wall 41 toward the outer periphery side, is run along the outer periphery of the external wall 41. As a result, the third U-phase crossover portion 49-U3 is formed due to the U-phase winding wire 46. Then, the winding machine moves the U-phase conducting wire nozzle in such a way that the U-phase winding wire 46, which is extended from the third U-phase crossover portion 49-U3, is passed through the corresponding slit 44; and then the U-phase winding wire 46, which is pulled in toward the inner periphery side of the external wall 41 from the outer periphery side, is wound around the fourth stator core teeth portion 32-4 in the counterclockwise (CCW) direction. As a result, the fourth U-phase winding wire 46-U4 is formed due to the U-phase winding wire 46.

At that time, the winding machine moves the V-phase conducting wire nozzle and the W-phase conducting wire nozzle in synchronization with the movement of the U-phase conducting wire nozzle; so that the third V-phase crossover portion 49-V3 is formed due to the V-phase conducting wire extending from the third V-phase winding wire 46-V3 and, at the same time, the third W-phase crossover portion 49-W3 is formed due to the W-phase winding wire 46 extending from the third W-phase winding wire 46-W3. In an identical manner, the winding machine moves the V-phase conducting wire nozzle in synchronization with the movement of the U-phase conducting wire nozzle, so that the V-phase winding wire 46, which is extended from the third V-phase crossover portion 49-V3, is passed through the corresponding slit 44 and is wound around the eighth stator core teeth portion 32-8 in the counterclockwise (CCW) direction. As a result, the fourth V-phase winding wire 46-V4 is formed due to the V-phase winding wire 46. Moreover, the winding machine moves the W-phase conducting wire nozzle in synchronization with the movement of the U-phase conducting wire nozzle, so that the W-phase winding wire 46, which is extended from the third W-phase crossover portion 49-W3, is passed through the corresponding slit 44 and is wound around the sixth stator core teeth portion 32-6 in the counterclockwise (CCW) direction. As a result, the fourth W-phase winding wire 46-W4 is formed due to the W-phase winding wire 46.

As a result of manufacturing the stator 22 as explained above, the first U-phase crossover portion 49-U1, the second U-phase crossover portion 49-U2, the third U-phase crossover portion 49-U3, the first V-phase crossover portion 49-V1, the second V-phase crossover portion 49-V2, the third V-phase crossover portion 49-V3, the first W-phase crossover portion 49-W1, the second W-phase crossover portion 49-W2, and the third W-phase crossover portion 49-W3 that are stretched on the outer periphery of the external wall 41 are positively sloped in FIG. 7 with respect to the circumferential direction of the external wall 41 and are stretched on the outer periphery at a distance from each other.

Lastly, the winding machine moves the U-phase conducting wire nozzle in such a way that the other end of the U-phase winding wire 46 is extended from the fourth stator core teeth portion 32-4 up to the end node E, thereby resulting in the formation of the first U-phase neutral wire 47-U1. At that time, the winding machine moves the V-phase conducting wire nozzle and the W-phase conducting wire nozzle in synchronization with the movement of the U-phase conducting wire nozzle, so that the other end of the V-phase winding wire 46 is extended from the eighth stator core teeth portion 32-8 up to the end node E thereby resulting in the formation of the first V-phase neutral wire 47-V1, and that the other end of the W-phase winding wire 46 is extended from the sixth stator core teeth portion 32-6 up to the end node E thereby resulting in the formation of the first W-phase neutral wire 47-W1.

In the first embodiment, the winding wires 46 are guided using three nozzles that are disposed at the nozzle pitch of 60°, and four winding portions 45 of a single phase are formed after every 90°. Accordingly, the crossover portions, which are stretched along the outer periphery of the external wall 41 of the lower insulator 25, have the angle of 90°.

As explained above, in the first embodiment, all winding portions 45 included in a single phase are formed without cutting the winding wire 46 midway during the winding process. That leads to the simplification of the winding movement of the nozzle that supplies the winding wire 46. That enables achieving improvement in the productivity of the three-phase motor 6.

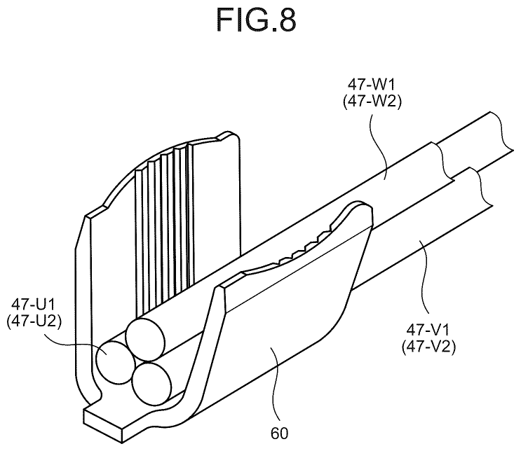

FIG. 8 is a perspective view of a splice terminal that constitutes the first neutral point 51A and the second neutral point 51B in the three-phase motor 6 according to the first embodiment. As illustrated in FIG. 8, an end of the first U-phase neutral wire 47-U1, an end of the first V-phase neutral wire 47-V1, and an end of the first W-phase neutral wire 47-W1 are, for example, sandwiched in a splice terminal 60 serving as a connector and are electrically connected, thereby resulting in the formation of the first neutral point 51A. In an identical manner, an end of the second U-phase neutral wire 47-U2, an end of the second V-phase neutral wire 47-V2, and an end of the second W-phase neutral wire 47-W2 are sandwiched in the splice terminal 60 and are electrically connected, thereby resulting in the formation of the second neutral point 51B. As a result of using the splice terminal 60, the connection of three neutral wires can be achieved with ease.

After performing the winding process as explained above, cutting is done at the start node S between the first U-phase power wire 48-U1 and the second U-phase power wire 48-U2; and the first U-phase power wire 48-U1 and the second U-phase power wire 48-U2 that are now separated from each other are connected to the U-phase power source. In an identical manner, cutting is done at the start node S between the first V-phase power wire 48-V1 and the second V-phase power wire 48-V2; and the first V-phase power wire 48-V1 and the second V-phase power wire 48-V2 that are now separated from each other are connected to the V-phase power source. Moreover, cutting is done at the start node S between the first W-phase power wire 48-W1 and the second W-phase power wire 48-W2; and the first W-phase power wire 48-W1 and the second W-phase power wire 48-W2 that are now separated from each other are connected to the W-phase power source.

Till now, the explanation was given about the case in which the winding wires 46 are wound according to three-nozzle winding using a winding machine that includes three nozzles. Alternatively, it is also possible to wind the winding wires 46 according to single-nozzle winding using a winding machine that includes only one nozzle. In that case, the U-phase winding wire 46, the V-phase winding wire 46, and the W-phase winding wire 46 are wound in a predetermined order on a phase-by-phase basis, and the winding portions 45 of the three phases are formed on a phase-by-phase basis. As a result of forming the winding portions 45 of the three phases as explained above, the stator 22 is manufactured.

### (Operations of Compressor)

The compressor 1 is installed as a constituent element of a freezing cycle device (not illustrated), and is used to compress the refrigerant and circulate the compressed refrigerant in a refrigerant circuit of the freezing cycle device. In the three-phase motor 6, when a three-phase voltage is applied to the first U-phase power wire 48-U1 and the second U-phase power wire 48-U2, to the first V-phase power wire 48-V1 and the second V-phase power wire 48-V2, and to the first W-phase power wire 48-W1 and the second W-phase power wire 48-W2; the three-phase motor 6 generates a rotating magnetic field. The rotor 21 rotates according to the rotating magnetic field generated by the stator 22. Due to the rotation of the rotor 21, the three-phase motor 6 rotates the rotary shaft 3.

When the rotary shaft 3 rotates, the compressing section 5 takes in a low-pressure refrigerant gas via the suction pipe 11; compresses the low-pressure refrigerant gas to generate a high-pressure refrigerant gas; and supplies the high-pressure refrigerant gas to the upper muffler chamber 16 and the lower muffler chamber 17. Herein, because of the lower muffler cover 15, there is a reduction in the pressure pulsation of the high-pressure refrigerant gas that is supplied to the lower muffler chamber 17, and the high-pressure refrigerant gas having a reduced pressure pulsation is supplied to the upper muffler chamber 16. Because of the upper muffler cover 14, there is a reduction in the pressure pulsation of the high-pressure refrigerant gas that is supplied to the upper muffler chamber 16, and the high-pressure refrigerant gas having a reduced pressure pulsation is supplied via the compressed-refrigerant discharge hole 18 to the space present in between the compressing section 5 and the three-phase motor 6 within the internal space 7.

The high-pressure refrigerant gas that is supplied in the space present in between the compressing section 5 and the three-phase motor 6 within the internal space 7 passes through the gaps formed in the three-phase motor 6, and reaches the space present above the three-phase motor 6 within the internal space 7. Then, the refrigerant that is supplied to the space present above the three-phase motor 6 within the internal space 7 is discharged via the discharge pipe 12 to those devices in the freezing cycle device which are disposed at the downstream side of the compressor 1.

### Effects of First Embodiment

In the three-phase motor manufacturing method for manufacturing the three-phase motor 6 according to the first embodiment, the winding wire 46 is continuously guided in order to enable the formation of all of a plurality of winding portions 45 of one of the three phases; and, in the process of forming the winding portions 45 of a single phase, when the winding portions 45 are viewed from the inner periphery side of the yoke portion 31 along a radial direction of the yoke portion 31, each winding portion 45 constituting one serial connection section from among the first serial connection section 52A and the second serial connection section 52B is formed by winding the winding wire (conducting wire) 46 in one direction (for example, the counterclockwise direction), and each winding portion 45 constituting the other serial connection section from among the first serial connection section 52A and the second serial connection section 52B is formed by winding the winding wire (conducting wire) 46 in the other direction (for example, the clockwise direction). As a result, all winding portions 45 of a single phase can be formed without having to cut the winding wire 46 during the winding process. That enables achieving enhancement in the productivity of the three-phase motor 6.

Moreover, in the three-phase motor manufacturing method for manufacturing the three-phase motor 6 according to the first embodiment, regarding one of the three phases such as the U phase, as illustrated in FIG. 6, the winding wire 46 is wound around the seventh winding portion [7], the 10-th winding portion [10], the first winding portion [1], and the fourth winding portion [4] in that order. Moreover, the conducting wire that is continuous with the winding wire 46 wound around the 10-th winding portion [10] is connected to the second U-phase power wire 48-U2, and the conducting wire that is continuous with the winding wire 46 wound around the first winding portion [1] is connected to the first U-phase power wire 48-U1. Furthermore, regarding the U phase, the conducting wire that is continuous with the winding wire 46 wound around the seventh winding portion [7] is connected to the second neutral point 51B, and the conducting wire that is continuous with the winding wire 46 wound around the fourth winding portion [4] is connected to the first neutral point 51A. As a result, from a single first stator core teeth portion 32-1, it is possible to draw two power wires 48, namely, the first U-phase power wire 48-U1 and the second U-phase power wire 48-U2. For that reason, for example, if the conducting wire that is continuous with the winding wire 46 wound around the first winding portion [1] is cut, both sides of the cut conducting wire can be connected to the U-phase power source so as to obtain two power wires 48. That enables achieving reduction in the man-hours needed in the formation of a plurality of power wires 48 included in a single phase. Meanwhile, as explained earlier, instead of starting the winding from the seventh winding portion [7], if the positions referred to as the first winding portion [1] to the 12-th winding portion [12] are shifted in such a way that the winding is started at the first winding portion [1] (i.e., if the seventh winding portion [7] is referred to as the first winding portion [1]), then the structure can be rephrased as the structure in which the winding is done in the first winding portion [1], the fourth winding portion [4], the seventh winding portion [7], and the 10-th winding portion [10] in that order. If the rephrasing is done in that way, then the conducting wire that is continuous with the winding wire 46 wound around the fourth winding portion [4] is connected to one of the power wires 48, and the conducting wire that is continuous with the winding wire 46 wound around the seventh winding portion [7] is connected to one of the power wires 48. Moreover, in that case, the conducting wire that is continuous with the winding wire 46 wound around the first winding portion [1] is connected to one of the neutral points 51, and the conducting wire that is continuous with the winding wire 46 wound around the 10-th winding portion [10] is connected to one of the neutral points 51.

Given below is the description of other embodiments. In the other embodiments, the constituent elements identical to the first embodiment are referred to by the same reference numerals, and their explanation is not given again. In second and third embodiments, the sequence in which a plurality of winding portions 45 is formed, that is, the guiding of the winding wires 46 is different than in the first embodiment.

### Second Embodiment

### (Wiring Structure of Winding Portions of Three Phases)

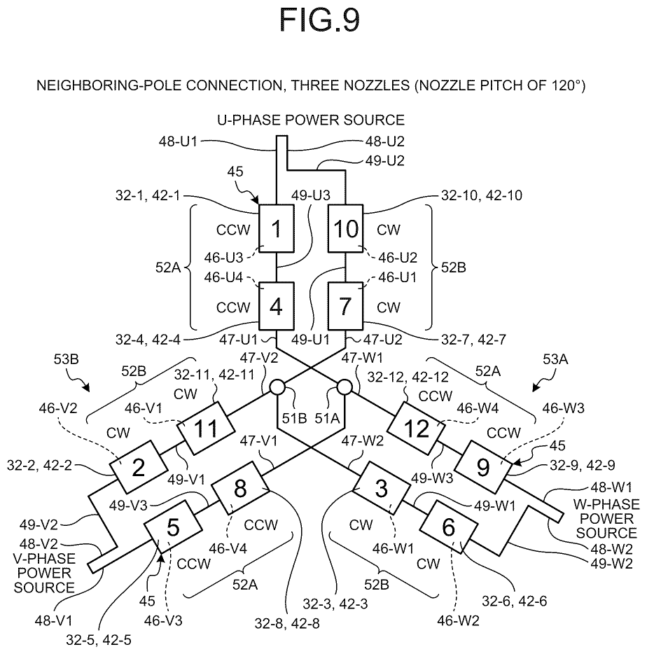

FIG. 9 is a connection wiring diagram illustrating the wiring state of the winding portions 45 of each phase according to the second embodiment. The wiring structure of the winding portions 45 of the second embodiment represents neighboring-pole connection in which, in the arrangement in which the winding portions 45 of each phase are repeated in the order of the U phase, the V phase, and the W phase in the circumferential direction of the stator core 23 in the arrangement in which the winding portions 45 of each phase are repeated in the order of the U phase, the V phase, and the W phase in the circumferential direction of the stator core 23, the neighboring winding portions 45 of the same phase in the arrangement direction of that phase are wired together.

As illustrated in FIG. 9, regarding the U phase and the V phase in the three-phase motor 6 according to the second embodiment, the order in which the winding portions 45 are connected to each other is identical to the order according to the first embodiment. However, the order in which the winding portions 45 of the W phase are connected to each other is different than the order according to the first embodiment. In other words, regarding the winding portions 45 of the W phase according to the second embodiment, in the winding process, the order of formation of the third winding portion [3], the sixth winding portion [6], the ninth winding portion [9], and the 12-th winding portion [12] is different than the order according to the first embodiment.

In an identical manner to the first embodiment, regarding the winding portions 45 of the W phase according to the second embodiment, the first serial connection section 52A, in which two winding portions 45 are serially connected, and the second serial connection section 52B, in which two winding portions 45 are serially connected, are connected in parallel to each other. Moreover, regarding the winding portions 45 of the W phase according to the second embodiment, each winding portion 45 in the first serial connection section 52A is formed as a result of counterclockwise (CCW) winding, and each winding portion 45 in the second serial connection section 52B is formed as a result of clockwise (CW) winding. Furthermore, regarding the winding portions 45 of the W phase according to the second embodiment, the first serial connection section 52A is made of the ninth winding portion [9] and the 12-th winding portion [12], and the second serial connection section 52B is made of the sixth winding portion [6] and the third winding portion [3].

With reference to FIG. 9, the first star connection body 53A according to the second embodiment includes six winding portions 45, namely, the first winding portion [1] and the fourth winding portion [4], the fifth winding portion [5] and the eighth winding portion [8], and the ninth winding portion and the 12-th winding portion [12], to which the first U-phase neutral wire 47-U1 (explained later), the first V-phase neutral wire 47-V1 (explained later), and the first W-phase neutral wire 47-W1 (explained later) are electrically connected via the first neutral point 51A. Moreover, with reference to FIG. 9, the second star connection body 53B includes six winding portions 45, namely, the 10-th winding portion [10] and the seventh winding portion [7], the second winding portion [2] and the 11-th winding portion [11], and the 12-th winding portion [12] and the ninth winding portion [9], to which the second U-phase neutral wire 47-U2 (explained later), the second V-phase neutral wire 47-V2 (explained later), and the third W-phase neutral wire 47-W2 (explained later) are electrically connected via the second neutral point 51B.

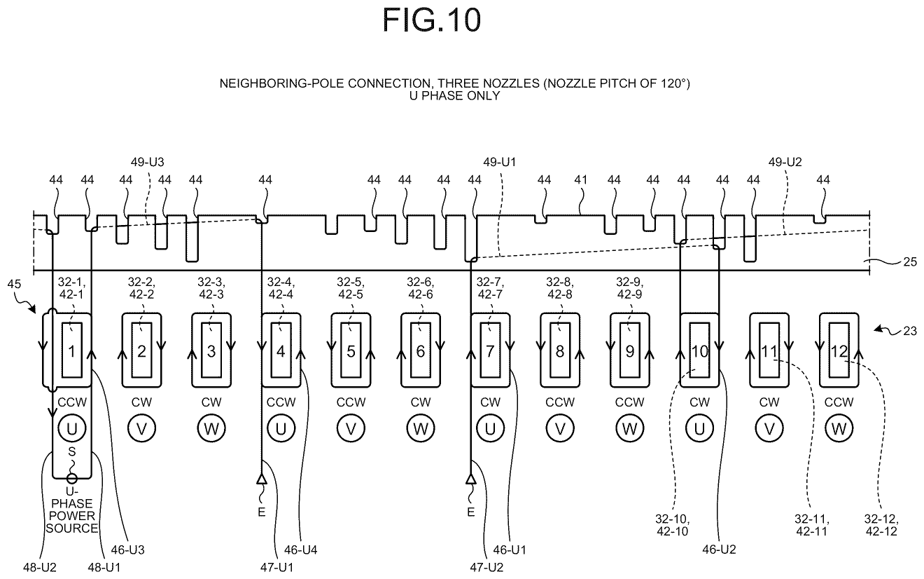

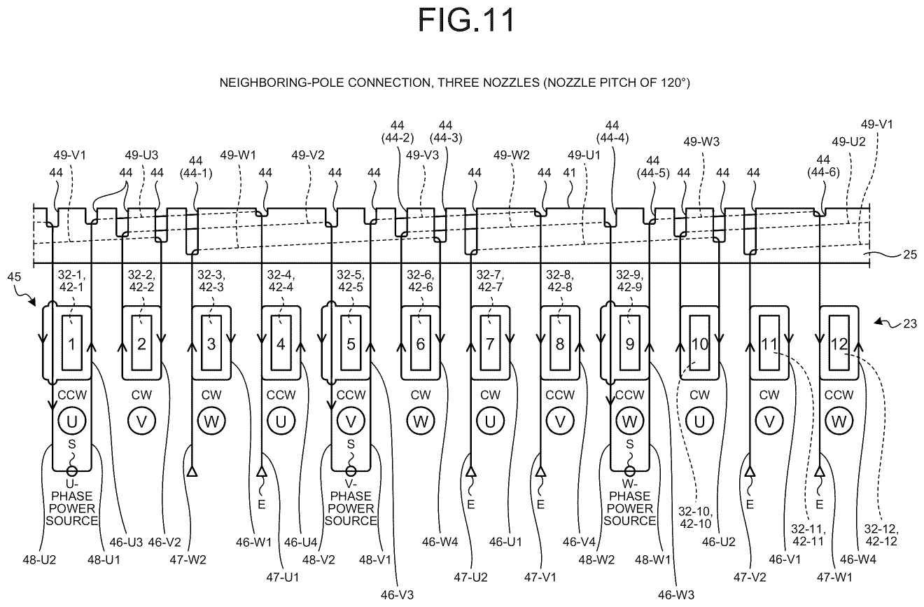

FIG. 10 is a development diagram for explaining the stretch path of the winding wire 46 that constitutes the winding portions 45 of the U phase according to the second embodiment. FIG. 11 is a development diagram for explaining the stretch paths of the winding wires 46 that constitute the winding portions 45 of the three phases according to the second embodiment. FIG. 11 is a development diagram illustrating the winding wires 46 of each phase that are wound around the lower insulator 25 and the stator core 23 according to the three-nozzle winding using three nozzles disposed at angles of 120° as the nozzle pitch representing the distance between the neighboring nozzles.

In the second embodiment, as illustrated in FIG. 10, the winding portions 45 of the U phase are formed in an identical order to the order according to the first embodiment. Moreover, as illustrated in FIG. 11, the winding portions 45 of the V phase are also formed in an identical order to the order according to the first embodiment. However, in the second embodiment, the order of formation of the winding portions 45 of the W phase is different than the order according to the first embodiment. Accordingly, as illustrated in FIG. 10, the positions of the slits 44 corresponding to the winding wires 46 of the W phase and the depths of the slits 44 with respect to the axial direction of the rotary shaft 3 are different than the explanation given with reference to FIG. 6 according to the first embodiment. In the second embodiment, a plurality of slits 44 can be formed in a line in such a way that their depths become gradually shallower toward one side in the circumferential direction of the external wall of the lower insulator 25, that is, toward the left side in FIGS. 10 and 11.

The winding portions 45 of the U phase and the V phase have an identical wiring structure to the wiring structure according to the first embodiment. Hence, that explanation is not given again. As illustrated in FIG. 11, in the W phase, the first W-phase winding wire 46-WI that is extended from the end node E connected to the second neutral point 51B is wound around the third stator core teeth portion 32-3 in the clockwise (CW) direction. Then, the first W-phase winding wire 46-W1 that is drawn from the third winding portion [3] of the third stator core teeth portion 32-3 is stretched from the inner periphery side of the external wall 41 of the lower insulator 25 along the outer periphery of the external wall 41 through the corresponding slit 44. As a result, the first W-phase crossover portion 49-W1 is formed. The second W-phase winding wire 46-W2 that is drawn from the first W-phase crossover portion 49-W1 to the inner periphery side of the external wall 41 through the corresponding slit 44 is wound around the sixth stator core teeth portion 32-6 in the clockwise (CW) direction.

Then, the second W-phase winding wire 46-W2 that is drawn from the sixth winding portion [6] of the sixth stator core teeth portion 32-6 is stretched from the inner periphery side of the lower insulator 25 of the external wall 41 along the outer periphery of the external wall 41 through the corresponding slit 44. As a result, the second W-phase crossover portion 49-W2 is formed. The third W-phase winding wire 46-W3 that is drawn from the second W-phase crossover portion 49-W2 to the inner periphery side of the external wall 41 through the corresponding slit 44 is extended as the start node S to be connected to the W-phase power source and, without being cut at the start node S, is continuously extended and wound around the ninth stator core teeth portion 32-9 in the counterclockwise (CCW) direction.

Then, the third W-phase winding wire 46-W3 that is drawn from the ninth winding portion [9] of the ninth stator core teeth portion 32-9 is stretched from the inner periphery side of the lower insulator 25 of the external wall 41 along the outer periphery of the external wall 41 through the corresponding slit 44. As a result, the third W-phase crossover portion 49-W3 is formed. The fourth W-phase winding wire 46-W4 that is drawn from the third W-phase crossover portion 49-W3 to the inner periphery side of the external wall 41 through the corresponding slit 44 is wound around the 12-th stator core teeth portion 32-12 in the counterclockwise (CCW) direction. Then, the fourth W-phase winding wire 46-W4 that is drawn from the 12-th winding portion [12] of the 12-th stator core teeth portion 32-12 is extended up to the end node E that is to be connected to the first neutral point 51A.

In this way, in the third stator core teeth portion 32-3, the sixth stator core teeth portion 32-6, the ninth stator core teeth portion 32-9, and the 12-th stator core teeth portion 32-12 in that order; the W-phase winding wires 46 constitute the winding portions 45 in a continuous manner without getting cut midway. In other words, the W-phase winding portions 45 are formed when the winding of the winding wires 46 is done in the third winding portion [3], the sixth winding portion [6], the ninth winding portion [9], and the 12-th winding portion [12] in that order. In this way, in the second embodiment, all winding portions 45 included in a single phase are formed without cutting the winding wire 46 midway during the winding process. That leads to the simplification of the winding movement of the nozzle that supplies the winding wire 46. That enables achieving improvement in the productivity of the three-phase motor 6.

Moreover, in the third W-phase winding wire 46-W3, the portion that is extended as the start node S to be connected to the W-phase power source is cut into two start nodes S in a subsequent process to the process of forming the W-phase winding portions 45 as explained above, and the two start nodes S are used as the first W-phase power wire 48-W1 (explained later) and the second W-phase power wire 48-W2 (explained later) and are connected to the W-phase power source.

Meanwhile, in the second embodiment, the winding of the W-phase winding wires 46 is done in the third winding portion [3], the sixth winding portion [6], the ninth winding portion [9], and the 12-th winding portion [12] in that order. However, instead of starting the winding from the third winding portion [3], if the positions referred to as the first winding portion [1] to the 12-th winding portion [12] are shifted in such a way that the winding is started at the first winding portion [1] (i.e., in the second embodiment, if the third winding portion [3] is referred to as the first winding portion [1]), then the structure can be rephrased as the structure in which the winding is done in the first winding portion [1], the fourth winding portion [4], the seventh winding portion [7], and the 10-th winding portion [10] in that order. That is, it can be said that the W-phase winding portions 45 are formed when the winding of the winding wires 46 is done in the first winding portion [1], the fourth winding portion [4], the seventh winding portion [7], and the 10-th winding portion [10] in that order. That order of winding is applicable in the U phase and the V phase too.

In the following explanation, the order of winding the W-phase winding wires 46 is rephrased in terms of the order of the slits 44 on the external wall 41 of the lower insulator 25 through which the W-phase winding wires 46 are passed. As illustrated in FIG. 11, the slit 44 that represents the first W-phase crossover portion 49-W1 through which the first W-phase winding wire 46-W1, which is drawn from the third winding portion [3], is passed is referred to as the first slit 44-1. Assume that the slits 44 through which the W-phase winding wires 46 are passed are referred to as the first slit 44-1, the second slit 44-2, the third slit 44-3, the fourth slit 44-4, the fifth slit 44-5, and the sixth slit 44-6 in that order of arrangement from the first slit 44—toward one side of the circumferential direction of the external wall 41 of the lower insulator 25, that is, toward the right side in FIG. 11. In that case, when the w-phase winding wires 46 are wound to form the third winding portion [3], the sixth winding portion [6], the ninth winding portion [9], and the 12-th winding portion [12] in that order; the W-phase winding wires 46 are passed through the first slit 44-1, the third slit 44-3, the second slit 44-2, the fourth slit 44-4, the fifth slit 44-5, and the sixth slit 44-6 in that order. In the U phase and the V phase too, the passage of the corresponding winding wires 46 through the first slit 44-1 to the sixth slit 44-6 occurs in the abovementioned order.

Moreover, regarding the W-phase winding wires 46, in the circumferential direction of the stator 22, the orientation of the electrical current flowing from the start node S, which is connected to the W-phase power source, toward the end node E via the ninth winding portion [9] and the 12-th winding portion [12] in that order is opposite to the orientation of the electrical current flowing from the start node S toward the end node E via the sixth winding portion [6] and the third winding portion [3] in that order. Hence, in order to match the direction in which the magnetic flux is generated in the four winding portions 45, the W-phase winding wires 46 are wound in the counterclockwise (CCW) direction around the ninth stator core teeth portion 32-9 and the 12-th stator core teeth portion 32-12 but are wound in the clockwise (CW) direction around the sixth stator core teeth portion 32-6 and the 12-th stator core teeth portion 32-12. In other words, from among the W-phase winding portions 45, the winding portions 45 included in the second serial connection section 52B of the two serial connection sections 52 (i.e., the third winding portion [3] and the sixth winding portion [6]) are formed by winding the winding wires 46 in the clockwise (CW) direction; and the winding portions 45 included in the first serial connection section 52A of the two serial connection sections 52 (i.e., the ninth winding portion [9] and the 12-th winding portion [12]) are formed by winding the winding wires 46 in the counterclockwise (CCW) direction.

Regarding the order of the slits 44 through which the W-phase winding wires 46 are passed, the two slits 44 through which the W-phase winding wires 46 are passed before and after the formation of the ninth winding portion [9] (i.e., the fourth slit 44-4 and the fifth slit 44-5) are referred to as a first slit pair for descriptive purposes. Moreover, the two slits 44 through which the W-phase winding wires 46 are passed before and after the formation of the sixth winding portion [6] (i.e., the second slit 44-2 and the third slit 44-3) are referred to as a second slit pair. At that time, the order in which the two slits 44 constituting the first slit pair (i.e., the fourth slit 44-4 and the fifth slit 44-5) are arranged toward one side of the circumferential direction of the external wall 41 matches with the order in which the winding wires 46 pass through those two slits 44 at the time of winding. On the other hand, the order in which the two slits 44 constituting the second slit pair (i.e., the second slit 44-2 and the third slit 44-3) are arranged toward one side of the circumferential direction of the external wall 41 is opposite to the order in which the winding wires 46 pass through those two slits 44 at the time of winding. As a result, even when the winding orientation of the winding wires 46 is reversed midway either from the clockwise (CW) direction to the counterclockwise (CCW) direction or from the counterclockwise (CCW) direction to the clockwise (CW) direction, that portion of the winding wire 46 which extends from a single slit 44 up to a single winding portion 45 can be drawn parallel to the axial direction of the rotary shaft 3 from that slit 44, thereby enabling achieving reduction in the load exerted on that portion of the winding wire 46 which is hooked in the slit 44.

(Three-Phase Motor Manufacturing Method) In the second embodiment, the winding wires 46 are wound around the stator core 23 according to the three-nozzle winding using a winding machine meant for three-nozzle winding. In the winding machine meant for three-nozzle winding; the U-phase conducting wire nozzle, the V-phase conducting wire nozzle, and the W-phase conducting wire nozzle are singularly disposed at angles of 120° around the central axis of the stator core 23.

The winding process for the winding portions 45 of the U phase and the V phase is identical to the winding process according to the first embodiment. Hence, that explanation is not given again. As illustrated in FIG. 11, the winding machine moves the W-phase conducting wire nozzle in synchronization with the movement of the U-phase conducting wire nozzle and the V-phase conducting wire nozzle. As a result, the W-phase winding wire 46 that is extended from the end node E is wound around the third stator core teeth portion 32-3 in the clockwise (CW) direction, and the first W-phase winding wire 46-W1 is formed due to the W-phase winding wire 46.

Then, the winding machine moves the W-phase conducting wire nozzle in such a way that the W-phase winding wire 46, which is extended from the first W-phase winding wire 46-W1, is passed through the corresponding slit 44 on the external wall 41; and then the W-phase winding wire 46, which is drawn from the inner periphery side of the external wall 41 toward the outer periphery side, is run along the outer periphery of the external wall 41. As a result, the first W-phase crossover portion 49-W1 is formed due to the W-phase winding wire 46. Then, the winding machine moves the W-phase conducting wire nozzle in such a way that the W-phase winding wire 46, which is extended from the first W-phase crossover portion 49-W1, is passed through the corresponding slit 44; and then the W-phase winding wire 46, which is pulled in toward the inner periphery side of the external wall 41 from the outer periphery side, is wound around the sixth stator core teeth portion 32-6 in the clockwise (CW) direction. As a result, the second W-phase winding wire 46-W2 is formed due to the W-phase winding wire 46.

Subsequently, the winding machine moves the W-phase conducting wire nozzle in such a way that the W-phase winding wire 46, which extends from the second W-phase winding wire 46-W2, is passed through the corresponding slit 44 on the external wall 41; and then the W-phase winding wire 46, which is drawn from the inner periphery side of the external wall 41 toward the outer periphery side, is run along the outer periphery of the external wall 41. As a result, the second W-phase crossover portion 49-U2 is formed due to the W-phase winding wire 46. Then, the winding machine moves the W-phase conducting wire nozzle in such a way that the W-phase winding wire 46, which is extended from the second W-phase crossover portion 49-W2, is passed through the corresponding slit 44; and then the W-phase winding wire 46, which is pulled in toward the inner periphery side of the external wall 41 from the outer periphery side, is extended as the first W-phase power wire 48-W1 and the second W-phase power wire 48-W2, and, without being cut at the start node S, is continuously extended and wound around the ninth stator core teeth portion 32-9 in the counterclockwise (CCW) direction. As a result, the third W-phase winding wire 46-W3 is formed due to the W-phase winding wire 46.

Subsequently, the winding machine moves the W-phase conducting wire nozzle in such a way that the W-phase winding wire 46, which is extended from the third W-phase winding wire 46-W3, is passed through the corresponding slit 44 on the external wall 41; and then the U-phase winding wire 46, which is drawn from the inner periphery side of the external wall 41 toward the outer periphery side, is run along the outer periphery of the external wall 41. As a result, the third W-phase crossover portion 49-W3 is formed due to the W-phase winding wire 46. Then, the winding machine moves the W-phase conducting wire nozzle in such a way that the W-phase winding wire 46, which is extended from the third W-phase crossover portion 49-W3, is passed through the corresponding slit 44; and then the W-phase winding wire 46, which is pulled in toward the inner periphery side of the external wall 41 from the outer periphery side, is wound around the 12-th stator core teeth portion 32-12 in the counterclockwise (CCW) direction. As a result, the fourth W-phase winding wire 46-W4 is formed due to the W-phase winding wire 46.

Lastly, the winding machine moves the W-phase conducting wire nozzle in such a way that the other end of the W-phase winding wire 46 is extended from the 12-th stator core teeth portion 32-12 up to the end node E, thereby resulting in the formation of the first W-phase neutral wire 47-W1.

In the second embodiment, the winding wires 46 are guided using three nozzles that are disposed at the nozzle pitch of 120°, and four winding portions 45 in a single phase are formed after every 90°. Accordingly, the crossover portions, which are stretched along the outer periphery of the external wall 41 of the lower insulator 25, have the angle of 90°. In this way, as a result of having the angle of the crossover portions to be smaller than the nozzle pitch, at the time of guiding the winding wires 46 using the three nozzles, when the nozzles move by 90° in order to form the crossover portions, since the nozzles are separated from each other by 120°, it becomes possible to avoid interference among the winding wires 46 of each phase. Hence, according to the second embodiment, it becomes possible to have a smooth angle of inclination of the crossover portions with respect to the circumferential direction of the external wall 41 of the lower insulator 25.

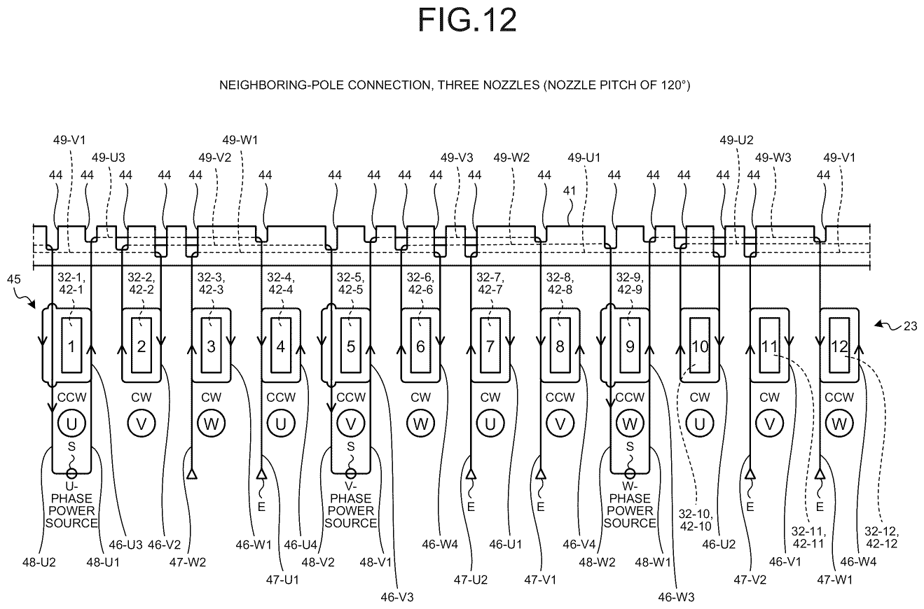

FIG. 12 is a development diagram for explaining a modification example of the stretch path of the winding wires 46 according to the second embodiment. Since it becomes possible to have a smooth angle of inclination of the crossover portions with respect to the circumferential direction of the external wall 41 of the lower insulator 25, the depth of the slits 44 formed on the external wall 41 can be adjusted in such a way that the crossover portions of each phase are parallel to the circumferential direction of the external wall 41 of the lower insulator 25. As a result, according to the modification example explained with reference to FIG. 12, the external wall 41 can be reduced in height in the axial direction of the rotary shaft 3 as compared to the first and second embodiments. Hence, according to the modification example, it becomes possible to downsize the three-phase motor 6 in the axial direction of the rotary shaft 3.

### Effects of Second Embodiment

In the three-phase motor manufacturing method for manufacturing the three-phase motor 6 according to the second embodiment too, in an identical manner to the first embodiment, the winding wire 46 constituting one of the three phases is continuously guided in order to enable the formation of a plurality of winding portions 45 of that phase. As a result, all winding portions 45 of a single phase can be formed without having to cut the winding wire 46 during the winding process. That enables achieving enhancement in the productivity of the three-phase motor 6.

### Third Embodiment

### (Wiring Structure of Winding Portions of Three Phases)

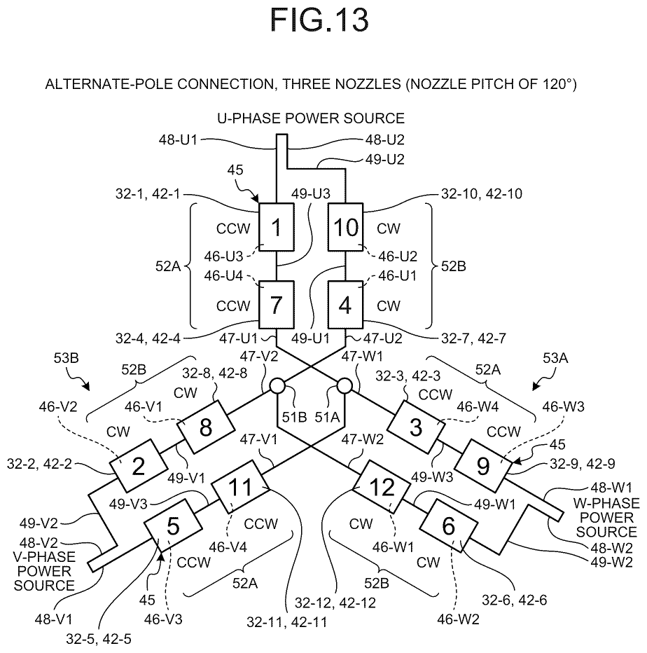

FIG. 13 is a connection wiring diagram illustrating the wiring state of the winding portions 45 of each phase according to the third embodiment. As compared to the neighboring-pole connection according to the first and second embodiments, the wiring structure of the winding portions 45 according to the third embodiment is different in the following way: in the arrangement in which the winding portions 45 of each phase are repeated in the order of the U phase, the V phase, and the W phase in the circumferential direction of the stator core 23; there is a portion in which, in the arrangement direction of each phase, wiring is done between the same phases after every other phase, that is, there is a portion in which poles in the same but alternately-appearing phases are wired in the phase arrangement direction (hereinafter, referred to as alternate-pole connection). Thus, the wiring structure is different than the neighboring-pole connection according to the first and second embodiments. As illustrated in FIG. 13, in the three-phase motor 6 according to the third embodiment, the arrangement of the winding portions 45 of the U phase, the V phase, and the W phase is different than the arrangement according to the first and second embodiments. In other words, the winding portions 45 of the U phase, V phase, and W phase according to the third embodiment are formed in a different order in the winding process than the order according to the first and second embodiments.

As illustrated in FIG. 13, regarding the winding portions 45 of the U phase, the V phase, and the W phase in the three-phase motor 6 according to the third embodiment, the first serial connection section 52A, in which two winding portions 45 are serially connected, and the second serial connection section 52B, in which two winding portions 45 are serially connected, are connected in parallel to each other. Regarding the winding portions 45 of the U phase, the V phase, and the W phase according to the third embodiment, each winding portion 45 in the first serial connection section 52A is formed due to winding in the counterclockwise (CCW) direction, and each winding portion 45 in the second serial connection section 52B is formed due to winding in the clockwise (CW) direction.

The first star connection body 53A according to the third embodiment includes, as illustrated in FIG. 13, six winding portions 45, namely, the first winding portion [1] and the seventh winding portion [7], the fifth winding portion [5] and the 11-th winding portion [11], and the ninth winding portion [9] and the third winding portion [3], to which the first U-phase neutral wire 47-U1, the first V-phase neutral wire 47-V1, and the first W-phase neutral wire 47-W1 are electrically connected via the first neutral point 51A. The second star connection body 53B includes, as illustrated in FIG. 13, six winding portions 45, namely, the 10-th winding portion [10] and the fourth winding portion [4], the second winding portion [2] and the eighth winding portion [8], and the sixth winding portion [6] and the 12-th winding portion [12], to which the second U-phase neutral wire 47-U2, the second V-phase neutral wire 47-V2, and the second W-phase neutral wire 47-W2 are electrically connected via the second neutral point 51B.

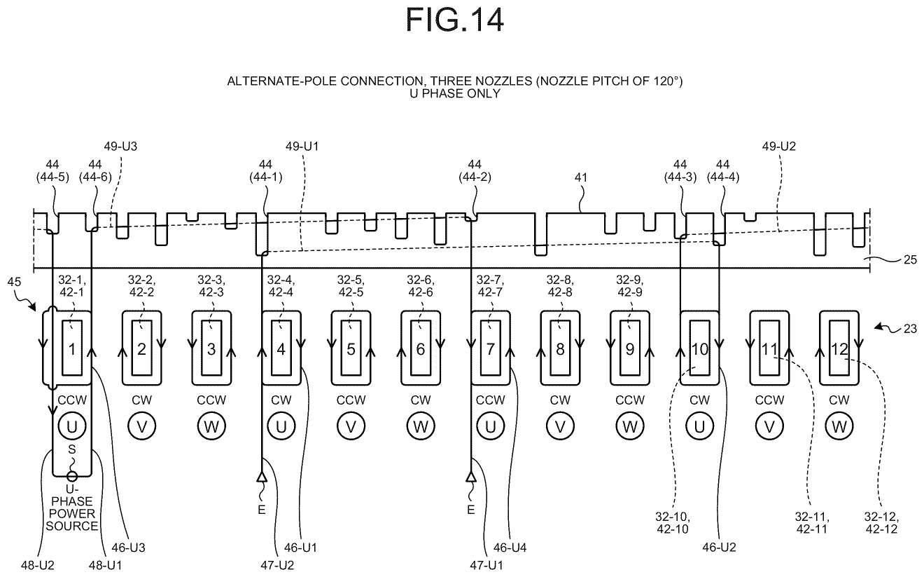

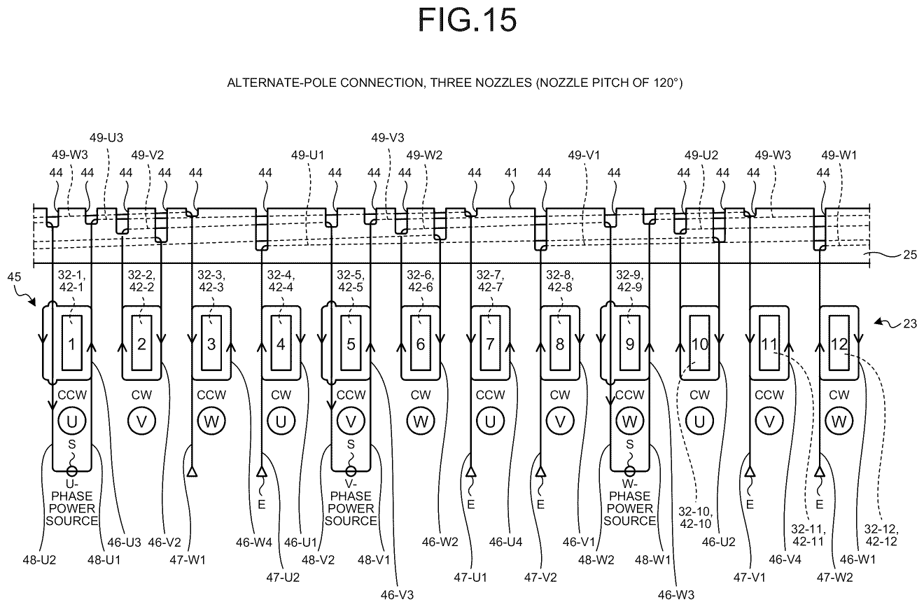

FIG. 14 is a development diagram for explaining the stretch path of the winding wire 46 that constitutes the winding portions 45 of the U phase according to the third embodiment. FIG. 15 is a development diagram for explaining the stretch paths of the winding wires 46 that constitute the winding portions 45 of the three phases according to the third embodiment.

As illustrated in FIG. 14, the first U-phase winding wire 46-U1 that is extended from the end node E connected to the second neutral point 51B is wound around the fourth stator core teeth portion 32-4 in the clockwise (CW) direction. Then, the first U-phase winding wire 46-U1 that is drawn from the fourth winding portion [4] of the fourth stator core teeth portion 32-7 is stretched from the inner periphery side of the external wall 41 of the lower insulator 25 along the outer periphery of the external wall 41 through the corresponding slit 44. As a result, the first U-phase crossover portion 49-U1 is formed. The second U-phase winding wire 46-U2 that is drawn from the first U-phase crossover portion 49-U1 to the inner periphery side of the external wall 41 through the corresponding slit 44 is wound around the 10-th stator core teeth portion 32-10 in the clockwise direction (CW), while skipping the seventh stator core teeth portion 32-7 that is adjacent to the fourth stator core teeth portion 32-4.

The second U-phase winding wire 46-2 that is drawn from the 10-th winding portion [10] of the 10-th stator core teeth portion 32-10 is stretched from the inner periphery side of the external wall 41 of the lower insulator 25 along the outer periphery of the external wall 41 through the corresponding slit 44. As a result, the second U-phase crossover portion 49-U2 is formed. The third U-phase winding wire 46-U3 that is drawn from the second U-phase crossover portion 49-U2 to the inner periphery side of the external wall 41 through the corresponding slit 44 is extended as the start node S to be connected to the U-phase power source and, without being cut at the start node S, is continuously extended and wound around the first stator core teeth portion 32-1 in the counterclockwise (CCW) direction.

The third U-phase winding wire 46-U3 that is drawn from the first winding portion [1] of the first stator core teeth portion 32-1 is stretched from the inner periphery side of the external wall 41 of the lower insulator 25 along the outer periphery of the external wall 41 through the corresponding slit 44. As a result, the third U-phase crossover portion 49-U3 is formed. The fourth U-phase winding wire 46-U4 that is drawn from the third U-phase crossover portion 49-U3 to the inner periphery side of the external wall 41 through the corresponding slit 44 is wound around the seventh stator core teeth portion 32-7 in the counterclockwise (CCW) direction, while skipping the fourth stator core teeth portion 32-4 that is adjacent to the first stator core teeth portion 32-1. The fourth U-phase winding wire 46-U4 that is drawn from the seventh winding portion [7] of the seventh stator core teeth portion 32-4 is extended up to the end node E that is connected to the first neutral point 51A.

In this way, in the fourth stator core teeth portion 32-4, the 10-th stator core teeth portion 32-10, the first stator core teeth portion 32-1, and the seventh stator core teeth portion 32-7 in that order; the U-phase winding wires 46 constitute the winding portions 45 in a continuous manner without getting cut midway. In the third U-phase winding wire 46-U3, the portion that is extended as the start node S to be connected to the U-phase power source is cut into two start nodes S in a subsequent process to the process of forming the U-phase winding portions 45 as explained above, and the two start nodes S are used as the first U-phase power wire 48-U1 (explained later) and the second U-phase power wire 48-U2 (explained later) and are connected to the U-phase power source.

Meanwhile, in the third embodiment, the U-phase winding wires 46 are wound in such a way that the U-phase winding portions 45 are formed in the fourth winding portion [4], the 10-th winding portion [10], the first winding portion [1], and the seventh winding portion [7] in that order. However, instead of starting the winding from the fourth winding portion [4], if the positions referred to as the first winding portion [1] to the 12-th winding portion [12] are shifted in such a way that the winding is started at the first winding portion [1] (i.e., in the third embodiment, if the fourth winding portion [4] is referred to as the first winding portion [1]), then the structure can be rephrased as the structure in which the winding is done in the first winding portion [1], the seventh winding portion [7], the 10-th winding portion [10], and the fourth winding portion [4] in that order. The same order of winding is applicable in the V phase and the W phase too.

In the following explanation, the order of winding the U-phase winding wires 46 is rephrased in terms of the order of the slits 44 on the external wall 41 of the lower insulator 25 through which the U-phase winding wires 46 are passed. As illustrated in FIG. 14, the slit 44 that represents the first U-phase crossover portion 49-U1 through which the first U-phase winding wire 46-U1, which is drawn from the fourth winding portion [4], is passed is referred to as the first slit 44-1. Assume that the slits 44 through which the U-phase winding wires 46 are passed are referred to as the first slit 44-1, the second slit 44-2, the third slit 44-3, the fourth slit 44-4, the fifth slit 44-5, and the sixth slit 44-6 in that order of arrangement toward one side of the circumferential direction of the external wall 41 of the lower insulator 25, that is, toward the right side in FIG. 14. In that case, when the U-phase winding wires 46 are wound to form the fourth winding portion [4], the 10-th winding portion [10], the first winding portion [1], and the seventh winding portion [7] in that order; the U-phase winding wires 46 are passed through the first slit 44-1, the fourth slit 44-4, the third slit 44-3, the fifth slit 44-5, the sixth slit 44-6, and the second slit 44-2 in that order. In the V phase and the W phase too, the passage of the corresponding winding wires 46 through the first slit 44-1 to the sixth slit 44-6 occurs in the abovementioned order.

Moreover, regarding the U-phase winding wires 46, in the circumferential direction of the stator 22, the orientation of the electrical current flowing from the start node S, which is connected to the U-phase power source, toward the end node E via the first winding portion [1] and the seventh winding portion [7] in that order is opposite to the orientation of the electrical current flowing from the start node S toward the end node E via the 10-th winding portion [10] and the fourth winding portion [4] in that order. Hence, in order to match the direction in which the magnetic flux is generated in the four winding portions 45, the U-phase winding wires 46 are wound in the clockwise (CW) direction around the 10-th winding portion [10] of the 10-th stator core teeth portion 32-10 and the fourth winding portion [4] of the fourth stator core teeth portion 32-4 but are wound in the counterclockwise (CCW) direction around the first winding portion [1] of the first stator core teeth portion 32-1 and the seventh winding portion [7] of the seventh stator core teeth portion 32-7.

As illustrated in FIG. 15, the first V-phase winding wire 46-V1 that is extended from the end node E connected to the second neutral point 51B is wound around the eighth stator core teeth portion 32-8 in the clockwise (CW) direction. The first V-phase winding wire 46-V1 that is drawn from the eighth winding portion [8] of the eighth stator core teeth portion 32-8 is stretched from the inner periphery side of the external wall 41 of the lower insulator 25 along the outer periphery of the external wall 41 of the corresponding slit 44. As a result, the first V-phase crossover portion 49-V1 is formed. The second V-phase winding wire 46-V2 that is drawn from the first V-phase crossover portion 49-V1 to the inner periphery side of the external wall 41 through the corresponding slit 44 is wound around the second stator core teeth portion 32-2 in the clockwise (CW) direction, while skipping the 11-th stator core teeth portion 32-11 that is adjacent to the eighth stator core teeth portion 32-8.

Subsequently, the second V-phase winding wire 46-V2 that is drawn from the second winding portion [2] of the second stator core teeth portion 32-2 is stretched from the inner periphery side of the external wall 41 of the lower insulator 25 along the outer periphery of the external wall 41 through the corresponding slit 44. As a result, the second V-phase crossover portion 49-V2 is formed. The third V-phase winding wire 46-V3 that is drawn from the second V-phase crossover portion 49-V2 to the inner periphery side of the external wall 41 through the corresponding slit 44 is extended as the start node S to be connected to the V-phase power source and, without being cut at the start node S, is continuously extended and wound around the fifth stator core teeth portion 32-5 in the counterclockwise (CCW) direction.

The third V-phase winding wire 46-V3 that is drawn from the fifth winding portion [5] of the fifth stator core teeth portion 32-5 is stretched from the inner periphery side of the external wall 41 of the lower insulator 25 along the outer periphery of the external wall 41 through the corresponding slit 44. As a result, the third V-phase crossover portion 49-V3 is formed. The fourth V-phase winding wire 46-V4 that is drawn from the third V-phase crossover portion 49-V3 to the inner periphery side of the external wall 41 through the corresponding slit 44 is wound around the 11-th stator core teeth portion 32-11 in the counterclockwise (CCW) direction, while skipping the eighth stator core teeth portion 32-8 that is adjacent to the fifth stator core teeth portion 32-5. Then, the fourth V-phase winding wire 46-V4 that is drawn from the 11-th winding portion [11] of the 11-th stator core teeth portion 32-11 is extended up to the end node E that is to be connected to the first neutral point 51A.

In this way, in the eighth stator core teeth portion 32-8, the second stator core teeth portion 32-2, the fifth stator core teeth portion 32-5, and the 11-th stator core teeth portion 32-11 in that order; the V-phase winding wires 46 constitute the winding portions 45 in a continuous manner without getting cut midway. In the third V-phase winding wire 46-V3, the portion that is extended as the start node S to be connected to the V-phase power source is cut into two start nodes S in a subsequent process to the process of forming the V-phase winding portions 45 as explained above, and the two start nodes S are used as the first V-phase power wire 48-V1 (explained later) and the second V-phase power wire 48-V2 (explained later) and are connected to the V-phase power source.

Moreover, regarding the V-phase winding wires 46, in the circumferential direction of the stator 22, the orientation of the electrical current flowing from the start node S, which is connected to the V-phase power source, toward the end node E via the fifth winding portion [5] and the 11-th winding portion [11] in that order is opposite to the orientation of the electrical current flowing from the start node S toward the end node E via the second winding portion [2] and the eighth winding portion [8] in that order. Hence, in order to match the direction in which the magnetic flux is generated in the four winding portions 45, the V-phase winding wires 46 are wound in the clockwise (CW) direction around the second stator core teeth portion 32-2 and the eighth stator core teeth portion 32-8 but are wound in the counterclockwise (CCW) direction around the fifth stator core teeth portion 32-5 and the 11-th stator core teeth portion 32-11.

As illustrated in FIG. 15, the first W-phase winding wire 46-W1 that is extended from the end node E connected to the second neutral point 51B is wound around the 12-th stator core teeth portion 32-12 in the clockwise (CW) direction. Then, the first W-phase winding wire 46-W1 that is drawn from the 12-th winding portion [12] of the 12-th stator core teeth portion 32-12 is stretched from the inner periphery side of the external wall 41 of the lower insulator 25 along the outer periphery of the external wall 41 of the corresponding slit 44. As a result, the first W-phase crossover portion 49-W1 is formed. The second W-phase winding wire 46-W2 that is drawn from the first W-phase crossover portion 49-W1 to the inner periphery side of the external wall 41 through the corresponding slit 44 is wound around the sixth stator core teeth portion 32-6 in the clockwise (CW) direction, while skipping the third stator core teeth portion 32-3 that is adjacent to the 12-th stator core teeth portion 32-12.

Subsequently, the second W-phase winding wire 46-W2 that is drawn from the sixth winding portion [6] of the sixth stator core teeth portion 32-6 is stretched from the inner periphery side of the external wall 41 of the lower insulator 25 along the outer periphery of the external wall 41 through the corresponding slit 44. As a result, the second W-phase crossover portion 49-W2 is formed. The third W-phase winding wire 46-W3 that is drawn from the second W-phase crossover portion 49-W2 to the inner periphery side of the external wall 41 through the corresponding slit 44 is extended as the start node S to be connected to the W-phase power source and, without being cut at the start node S, is continuously extended and wound around the ninth stator core teeth portion 32-9 in the counterclockwise (CCW) direction.

Then, the third W-phase winding wire 46-W3 that is drawn from the ninth winding portion [9] of the ninth stator core teeth portion 32-9 is stretched from the inner periphery side of the external wall 41 of the lower insulator 25 along the outer periphery of the external wall 41 through the corresponding slit 44. As a result, the third W-phase crossover portion 49-W3 is formed. The fourth W-phase winding wire 46-W4 that is drawn from the third w-phase crossover portion 49-W3 to the inner periphery side of the external wall 41 through the corresponding slit 44 is wound around the third stator core teeth portion 32-3 in the counterclockwise (CCW) direction, while skipping the 12-th stator core teeth portion 32-12 that is adjacent to the ninth stator core teeth portion 32-9. Then, the fourth W-phase winding wire 46-W4 that is drawn from the third winding portion [3] of the third stator core teeth portion 32-3 is extended up to the end node E that is to be connected to the first neutral point 51A.

In this way, in the 12-th stator core teeth portion 32-12, the sixth stator core teeth portion 32-6, the ninth stator core teeth portion 32-9, and the third stator core teeth portion 32-3 in that order; the W-phase winding wires 46 constitute the winding portions 45 in a continuous manner without getting cut midway. In the third W-phase winding wire 46-W3, the portion that is extended as the start node S to be connected to the W-phase power source is cut into two start nodes S in a subsequent process to the process of forming the W-phase winding portions 45 as explained above, and the two start nodes S are used as the first W-phase power wire 48-W1 (explained later) and the second W-phase power wire 48-W2 (explained later) and are connected to the W-phase power source.

Moreover, regarding the W-phase winding wires 46, in the circumferential direction of the stator 22, the orientation of the electrical current flowing from the start node S, which is connected to the W-phase power source, toward the end node E via the sixth winding portion [6] and the 12-th winding portion [12] in that order is opposite to the orientation of the electrical current flowing from the start node S toward the end node E via the ninth winding portion [9] and the third winding portion [3] in that order. Hence, in order to match the direction in which the magnetic flux is generated in the four winding portions 45, the W-phase winding wires 46 are wound in the clockwise (CW) direction around the sixth stator core teeth portion 32-6 and the 12-th stator core teeth portion 32-12 but are wound in the counterclockwise (CCW) direction around the ninth stator core teeth portion 32-9 and the third stator core teeth portion 32-3.

### (Three-Phase Motor Manufacturing Method)

In the second embodiment, the winding wires 46 are wound around the stator core 23 according to the three-nozzle winding using a winding machine meant for three-nozzle winding. In the winding machine meant for three-nozzle winding; the U-phase conducting wire nozzle, the V-phase conducting wire nozzle, and the W-phase conducting wire nozzle are singularly disposed at angles of 120° around the central axis of the stator core 23.

The winding machine winds the U-phase winding wire 46, which is extended from the end node E, around the fourth stator core teeth portion 32-4 in the clockwise (CW) direction, thereby resulting in the formation of the first U-phase winding wire 46-U1 due to the U-phase winding wire 46. At that time, the winding machine moves the V-phase conducting wire nozzle in synchronization with the movement of the U-phase conducting wire nozzle and winds the V-phase winding wire 46, which is extended from the end node E, around the eighth stator core teeth portion 32-8 in the clockwise (CW) direction, thereby resulting in the formation of the first V-phase winding wire 46-V1 due to the V-phase winding wire 46. Moreover, the winding machine moves the W-phase conducting wire nozzle in synchronization with the movement of the U-phase conducting wire nozzle and winds the W-phase winding wire 46, which is extended from the end node E, around the 12-th stator core teeth portion 32-12 in the clockwise (CW) direction, thereby resulting in the formation of the first w-phase winding wire 46-W1 due to the W-phase winding wire 46.

Subsequently, the winding machine moves the U-phase conducting wire nozzle in such a way that the U-phase winding wire 46, which is extended from the first U-phase winding wire 46-U1, is passed through the corresponding slit 44 on the external wall 41; and then the U-phase winding wire 46, which is drawn from the inner periphery side of the external wall 41 toward the outer periphery side, is run along the outer periphery of the external wall 41. As a result, the first U-phase crossover portion 49-U1 is formed due to the U-phase winding wire 46. Then, the winding machine moves the U-phase conducting wire nozzle to the 10-th stator core teeth portion 32-10 while skipping the seventh stator core teeth portion 32-7 that is adjacent to the fourth stator core teeth portion 32-4. Hence, the U-phase winding wire 46, which is extended from the first U-phase crossover portion 49-U1, is passed through the corresponding slit 44; and then the U-phase winding wire 46, which is pulled in toward the inner periphery side of the external wall 41 from the outer periphery side, is wound around the 10-th stator core teeth portion 32-10 in the clockwise (CW) direction. As a result, the second U-phase winding wire 46-U2 is formed due to the U-phase winding wire 46.

At that time, due to the V-phase winding wire 46 that is extended from the first V-phase winding wire 46-V1, the first V-phase crossover portion 49-V1 is formed. Moreover, at the same time, due to the W-phase winding wire 46 that is extended from the first W-phase winding wire 46-W1, the first W-phase crossover portion 49-W1 is formed. In an identical manner, the winding machine meant for three-nozzle winding moves the V-phase conducting wire nozzle, in synchronization with the movement of the U-phase conducting wire nozzle, to the second stator core teeth portion 32-2 while skipping the 11-th stator core teeth portion 32-11 that is adjacent to the eighth stator core teeth portion 32-8. Hence, the V-phase winding wire, which is extended from the first V-phase crossover portion 49-V1, is passed through the corresponding slit 44 and is wound around the second stator core teeth portion 32-2 in the clockwise (CW) direction. As a result, the second V-phase winding wire 46-V2 is formed due to the V-phase winding wire 46. Moreover, the winding machine meant for three-nozzle winding moves the w-phase conducting wire nozzle, in synchronization with the movement of the U-phase conducting wire nozzle, to the sixth stator core teeth portion 32-6 while skipping the third stator core teeth portion 32-3 that is adjacent to the 12-th stator core teeth portion 32-12. Hence, the W-phase conducting wire, which is extended from the first W-phase crossover portion 49-W1, is passed through the corresponding slit 44 and is wound around the sixth stator core teeth portion 32-6 in the clockwise (CW) direction. As a result, the second W-phase winding wire 46-W2 is formed due to the w-phase winding wire 46.

Subsequently, the winding machine moves the U-phase conducting wire nozzle in such a way that the U-phase winding wire 46, which extends from the second U-phase winding wire 46-U2, is passed through the corresponding slit 44 on the external wall 41; and then the U-phase winding wire 46, which is drawn from the inner periphery side of the external wall 41 toward the outer periphery side, is run along the outer periphery of the external wall 41. As a result, the second U-phase crossover portion 49-U2 is formed due to the U-phase winding wire 46. Then, the winding machine moves the U-phase conducting wire nozzle in such a way that the U-phase winding wire 46, which is extended from the second U-phase crossover portion 49-U2, is passed through the corresponding slit 44; and then the U-phase winding wire 46, which is pulled in toward the inner periphery side of the external wall 41 from the outer periphery side, is extended as the first U-phase power wire 48-U1 and the second U-phase power wire 48-U2, and, without being cut at the start node S, is continuously extended and wound around the first stator core teeth portion 32-1 in the counterclockwise (CCW) direction. As a result, the third U-phase winding wire 46-U3 is formed due to the U-phase winding wire 46.

At that time, the winding machine moves the V-phase conducting wire nozzle and the W-phase conducting wire nozzle in synchronization with the movement of the U-phase conducting wire nozzle; so that the second V-phase crossover portion 49-V2 is formed due to the V-phase winding wire 46 extending from the second V-phase winding wire 46-V2 and, at the same time, the second W-phase crossover portion 49-W2 is formed due to the W-phase winding wire 46 extending from the second W-phase winding wire 46-W2. In an identical manner, the winding machine moves the V-phase conducting wire nozzle in synchronization with the movement of the U-phase conducting wire nozzle, so that the V-phase winding wire 46, which is extended from the second V-phase crossover portion 49-V2, is passed through the corresponding slit 44; and then the V-phase winding wire 46, which is pulled in toward the inner periphery side of the external wall 41 from the outer periphery side, is extended as the first V-phase power wire 48-V1 and the second V-phase power wire 48-V2, and, without being cut at the start node S, is continuously extended and wound around the fifth stator core teeth portion 32-5 in the counterclockwise (CCW) direction. As a result, the third V-phase winding wire 46-V3 is formed due to the V-phase winding wire 46. Moreover, in an identical manner, the winding machine moves the W-phase conducting wire nozzle in synchronization with the movement of the U-phase conducting wire nozzle, so that the W-phase conducting wire, which is extended from the second W-phase crossover portion 49-W2, is passed through the corresponding slit 44; and then the W-phase winding wire 46, which is pulled in toward the inner periphery side of the external wall 41 from the outer periphery side, is extended as the first W-phase power wire 48-W1 and the second W-phase power wire 48-W2, and, without being cut at the start node S, is continuously extended and wound around the ninth stator core teeth portion 32-9 in the counterclockwise (CCW) direction. As a result, the third W-phase winding wire 46-W3 is formed due to the W-phase winding wire 46.

Subsequently, the winding machine moves the U-phase conducting wire nozzle in such a way that the U-phase winding wire 46, which is extended from the third U-phase winding wire 46-U3, is passed through the corresponding slit 44 on the external wall 41; and then the U-phase winding wire 46, which is drawn from the inner periphery side of the external wall 41 toward the outer periphery side, is run along the outer periphery of the external wall 41. As a result, the third U-phase crossover portion 49-U3 is formed due to the U-phase winding wire 46. Then, the winding machine moves the U-phase conducting wire nozzle to the seventh stator core teeth portion 32-7 while skipping the fourth stator core teeth portion 32-4 that is adjacent to the first stator core teeth portion 32-1. Hence, the U-phase winding wire 46, which is extended from the third U-phase crossover portion 49-U3, is passed through the corresponding slit 44; and then the U-phase winding wire 46, which is pulled in toward the inner periphery side of the external wall 41 from the outer periphery side, is wound around the seventh stator core teeth portion 32-7 in the counterclockwise (CCW) direction. As a result, the fourth U-phase winding wire 46-U4 is formed due to the U-phase winding wire 46.

At that time, the winding machine moves the V-phase conducting wire nozzle and the W-phase conducting wire nozzle in synchronization with the movement of the U-phase conducting wire nozzle; so that the third V-phase crossover portion 49-V3 is formed due to the V-phase conducting wire extending from the third V-phase winding wire 46-V3 and, at the same time, the third W-phase crossover portion 49-W3 is formed due to the W-phase winding wire 46 extending from the third W-phase winding wire 46-W3. In an identical manner, the winding machine moves the V-phase conducting wire nozzle, in synchronization with the movement of the U-phase conducting wire nozzle, to the 11-th stator core teeth portion 32-11 while skipping the eighth stator core teeth portion 32-8 that is adjacent to the fifth stator core teeth portion 32-5. Hence, the V-phase winding wire 46, which is extended from the third V-phase crossover portion 49-V3, is passed through the corresponding slit 44 and is wound around the 11-th stator core teeth portion 32-11 in the counterclockwise (CCW) direction. As a result, the fourth V-phase winding wire 46-V4 is formed due to the V-phase winding wire 46. Moreover, the winding machine moves the W-phase conducting wire nozzle, in synchronization with the movement of the U-phase conducting wire nozzle, to the third stator core teeth portion 32-3 while skipping the 12-th stator core teeth portion 32-12 that is adjacent to the ninth stator core teeth portion 32-9. Hence, the W-phase winding wire 46, which is extended from the third W-phase crossover portion 49-W3, is passed through the corresponding slit 44 and is wound around the third stator core teeth portion 32-3 in the counterclockwise (CCW) direction. As a result, the fourth W-phase winding wire 46-W4 is formed due to the W-phase winding wire 46.

As a result of manufacturing the stator 22 as explained above, the first U-phase crossover portion 49-U1, the second U-phase crossover portion 49-U2, the third U-phase crossover portion 49-U3, the first V-phase crossover portion 49-V1, the second V-phase crossover portion 49-V2, the third V-phase crossover portion 49-V3, the first W-phase crossover portion 49-W1, the second W-phase crossover portion 49-W2, and the third W-phase crossover portion 49-W3 that are stretched on the outer periphery of the external wall 41 are positively sloped in FIG. 15 with respect to the circumferential direction of the external wall 41 and are stretched on the outer periphery at a distance from each other.

Lastly, the winding machine moves the U-phase conducting wire nozzle in such a way that the other end of the U-phase winding wire 46 is extended from the fourth stator core teeth portion 32-4 up to the end node E, thereby resulting in the formation of the first U-phase neutral wire 47-U1. At that time, the winding machine moves the V-phase conducting wire nozzle and the W-phase conducting wire nozzle in synchronization with the movement of the U-phase conducting wire nozzle, so that the other end of the V-phase winding wire 46 is extended from the 11-th stator core teeth portion 32-11 up to the end node E thereby resulting in the formation of the first V-phase neutral wire 47-V1, and that the other end of the W-phase winding wire 46 is extended from the third stator core teeth portion 32-3 up to the end node E thereby resulting in the formation of the first W-phase neutral wire 47-W1.

As explained above, all winding portions 45 included in a single phase are formed without cutting the winding wire 46 midway during the winding process. That leads to the simplification of the winding movement of the nozzle that supplies the winding wire 46. That enables achieving improvement in the productivity of the three-phase motor 6.

### Effects of Third Embodiment

In the three-phase motor manufacturing method for manufacturing the three-phase motor 6 according to the third embodiment too, in an identical manner to the first embodiment, the winding wire 46 constituting one of the three phases is continuously guided in order to enable the formation of a plurality of winding portions 45 of that phase. As a result, all winding portions 45 of a single phase can be formed without having to cut the winding wire 46 during the winding process. That enables achieving enhancement in the productivity of the three-phase motor 6.

In the three-phase motor manufacturing method for manufacturing the three-phase motor 6 according to the third embodiment, regarding one of the three phases such as the U phase, as illustrated in FIG. 14, the winding is done around the fourth winding portion [4], the 10-th winding portion [10], the first winding portion [1], and the seventh winding portion [7] in that order. The conducting wire that is continuous with the winding wire 46 wound around the 10-th winding portion [10] is connected to the second U-phase power wire 48-U2, and the conducting wire that is continuous with the winding wire 46 wound around the first winding portion [1] is connected to the first U-phase power wire 48-U1. Furthermore, regarding the U phase, the conducting wire that is continuous with the winding wire 46 wound around the fourth winding portion [4] is connected to the second neutral point 51B, and the conducting wire that is continuous with the winding wire 46 wound around the seventh winding portion [7] is connected to the first neutral point 51A. As a result, from a single first stator core teeth portion 31-1, it is possible to draw two power wires 48, namely, the first U-phase power wire 48-U1 and the second U-phase power wire 48-U2. Meanwhile, instead of starting the winding from the fourth winding portion [4], if the positions referred to as the first winding portion [1] to the 12-th winding portion are shifted in such a way that the winding is started at the first winding portion [1] (i.e., if the fourth winding portion [4] is referred to as the first winding portion [1]), then the structure can be rephrased as the structure in which the winding is done in the first winding portion [1], the seventh winding portion [7], the 10-th winding portion [10], and the fourth winding portion [4] in that order. If the rephrasing is done in that way, then the conducting wire that is continuous with the winding wire 46 wound around the seventh winding portion [7] is connected to one of the power wires 48, and the conducting wire that is continuous with the winding wire 46 wound around the 10-th winding portion [10] is connected to one of the power wires 48. Moreover, in that case, the conducting wire that is continuous with the winding wire 46 wound around the first winding portion [1] is connected to one of the neutral points 51, and the conducting wire that is continuous with the winding wire 46 wound around the fourth winding portion [4] is connected to one of the neutral points 51.

### Modification Example

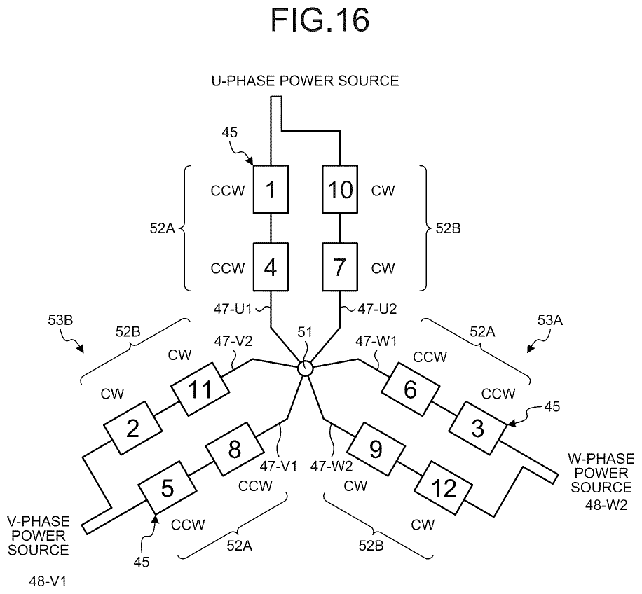

FIG. 16 is a connection wiring diagram illustrating the wiring state of the winding portions 45 in the case in which only a single neutral point 51 is present according to a modification example. In the first to third embodiments described above, the first star connection body 53A and the second star connection body 53B are wired via the first neutral point 51A and the second neutral point 51B. However, that is not the only possible structure. Alternatively, as illustrated in FIG. 16, the first star connection body 53A and the second star connection body 53B can be wired via only a single neutral point 51. In the modification example, the first U-phase neutral wire 47-U1 and the second U-phase neutral wire 47-U2, the first V-phase neutral wire 47-V1 and the second V-phase neutral wire 47-V2, and the first W-phase neutral wire 47-W1 and the second W-phase neutral wire 47-W2 are connected to a single neutral point 51. Hence, in each of the three phases, the first star connection body 53A and the second star connection body 53B are connected via only a single neutral point 51.

Meanwhile, in the three-phase motor 6 according to the embodiments, the first serial connection section 52A and the second serial connection section 52B are connected in parallel in each of the U phase, the V phase, and the W phase. However, the number of serial connection sections, in which two or more winding portions are serially connected, is not limited to two. For example, if the three-phase motor according to the present invention has 18 slots, then each phase can be configured to include three serial connection sections that are connected in parallel to each other. Moreover, the number of serial connection sections connected in parallel to each other can be equal to or greater than three.

### REFERENCE SIGNS LIST

1 compressor
6 three-phase motor
21 rotor
22 stator
23 stator core
24 upper insulator (insulator)
25 lower insulator (insulator)
31 yoke portion
32-1 to 32-12 stator core teeth portion (teeth portion)
44 (44-1 to 44-6) slit (first slit to sixth slit)
45 winding portion
46 winding (conducting wire)
48-U1 first U-phase power wire
48-U2 second U-phase power wire
48-V1 first V-phase power wire
48-V2 second V-phase power wire
48-W1 first W-phase power wire
48-W2 second W-phase power wire
49-U1 first U-phase crossover portion (crossover)
49-U2 second U-phase crossover portion (crossover)
49-U3 third U-phase crossover portion (crossover)
49-V1 first V-phase crossover portion (crossover)
49-V2 second V-phase crossover portion (crossover)
49-V3 third V-phase crossover portion (crossover)
49-W1 first W-phase crossover portion (crossover)
49-W2 second W-phase crossover portion (crossover)
49-W3 third W-phase crossover portion (crossover)
51A first neutral point
51B second neutral point
52A first serial connection section
52B second serial connection section
53A first star connection body
53B second star connection body
60 splice terminal

1. A three-phase motor manufacturing method for manufacturing a three-phase motor that includes
a stator core which includes
a ring-like yoke portion, and
a plurality of teeth portions that protrudes from the yoke portion toward inside in a radial direction of the yoke portion, and
a plurality of winding portions each of which is formed by winding a conducting wire to one of the teeth portions of the stator core,
each phase from among three phases, includes
a first serial connection section in which two or more of the winding portions are serially connected, and
a second serial connection section in which two or more of the winding portions are serially connected, and
the first serial connection section and the second serial connection section being connected in parallel,
the three-phase motor manufacturing method comprising forming that includes
continuously guiding the conducting wire, and
forming all of the plurality of winding portions of one phase from among the three phases, wherein
when winding portions are viewed from inner periphery side of the yoke portion along a radial direction of the yoke portion, the forming of the winding portions includes
winding the conducting wire in one direction and forming the winding portions included in one serial connection section from among the first serial connection section and the second serial connection section, and
winding the conducting wire in other direction and forming the winding portions included in other serial connection section from among the first serial connection section and the second serial connection section.

2. The three-phase motor manufacturing method according to claim 1, wherein
in the three-phase motor, a first star connection body and a second star connection body are present, each of which includes 3M number of winding portions where M represents an integer equal to or greater than 2, and
M number of the winding portions of the one phase are formed by guiding a single of the conducting wire without cutting.

3. The three-phase manufacturing method according to claim 2, wherein, when the winding portions are viewed from the inner periphery side in the radial direction, from among the first star connection body and the second star connection body, the winding portions constituting one star connection body are formed by winding a conducting wire in one direction, and the winding portions constituting other star connection body are formed by winding a conducting wire in other direction.

4. The three-phase manufacturing method according to claim 1, wherein
in the three-phase motor, 12 of the winding portions are arranged in such a way that the winding portions of each phase are repeated in same order of phases along circumferential direction of the stator core, and
when the 12 winding portions are referred to as a first winding portion to a 12-th winding portion in a sequential manner along circumferential direction of the stator core, the winding portions are formed in such a way that winding portions in the one phase include a first winding portion, a fourth winding portion, a seventh winding portion, and a 10-th winding portion.

5. The three-phase manufacturing method according to claim 4, wherein
in the one phase, winding portions are formed in order of the first winding portion, the fourth winding portion, the seventh winding portion, and the 10-th winding portion,
the first winding portion and the fourth winding portion are formed by winding the conducting wire in the one direction, and
the seventh winding portion and the 10-th winding portion are formed by winding the conducting wire in the other direction.

6. The three-phase manufacturing method according to claim 5, wherein
the three-phase motor includes an insulator attached to an end portion in axial direction of the stator core, the insulator having a plurality of slits formed thereon for allowing passage of crossovers that lead to the wiring portions, and
when a plurality of slits, through which a single conductor wire meant for forming a plurality of wiring portions in the one phase is passed, is referred to as a first slit, a second slit, a third slit, a fourth slit, a fifth slit, and a sixth slit in that order toward one side of circumferential direction of the insulator,
the single conducting wire is passed through the first slit, the third slit, the second slit, the fourth slit, the fifth slit, and the sixth slit in that order.

7. The three-phase manufacturing method according to claim 5, wherein
regarding conducting wires meant for forming a plurality of wiring portions in the one phase,
a conducting wire that is continuous with the fourth winding portion and a conducting wire that is continuous with the seventh winding portion are connected to power wires, and
a conducting wire that is continuous with the first wiring portion and a conducting wire that is continuous with the 10-th wiring portion are connected to neutral points.

8. The three-phase manufacturing method according to claim 4, wherein
a plurality of wiring portions in the one phase are formed when a conducting wire is wound in the first winding portion, the seventh winding portion, the 10-th winding portion, and the fourth winding portion in that order,
the first winding portion and the seventh winding portion are formed by winding the conducting wire in the one direction, and
the 10-th winding portion and the fourth winding portion are formed by winding the conducting wire in the other direction.

9. The three-phase manufacturing method according to claim 8, wherein
the three-phase motor includes an insulator attached to an end portion in axial direction of the stator core, the insulator having a plurality of slits formed thereon for allowing passage of crossovers which represent portions drawn to outer periphery side of the insulator via the slits, and
when a plurality of slits, through which a single conductor wire meant for forming a plurality of wiring portions in the one phase is passed, is referred to as a first slit, a second slit, a third slit, a fourth slit, a fifth slit, and a sixth slit in that order toward one side of circumferential direction of the insulator,
the single conducting wire is passed through the first slit, the fourth slit, the third slit, the fifth slit, the sixth slit, and the second slit in that order.

10. The three-phase manufacturing method according to claim 8, wherein
regarding conducting wires meant for forming a plurality of wiring portions in the one phase,
a conducting wire that is continuous with the seventh winding portion and a conducting wire that is continuous with the 10-th winding portion are connected to power wires, and
a conducting wire that is continuous with the first wiring portion and a conducting wire that is continuous with the fourth wiring portion are connected to neutral points.

11. The three-phase manufacturing method according to claim 1, wherein
two neutral points are present in the three-phase motor,
the first serial connection section in each of three phases is connected via one neutral point from among the two neutral points, and
the second serial connection section in each of three phases is connected via other neutral point from among the two neutral points.

12. The three-phase manufacturing method according to claim 1, wherein the first serial connection section and the second serial connection section in each of three phases are connected via a single neutral point.

13. The three-phase manufacturing method according to claim 1, wherein, using a winding machine that includes three nozzles meant for supplying a conducting wire for each phase, the three nozzles are moved in synchronization and winding portions of the each phase are formed in a simultaneous manner.

14. A three-phase motor comprising:
a stator core which includes
a ring-like yoke portion, and
a plurality of teeth portions that protrudes from the yoke portion toward inside in a radial direction of the yoke portion; and
a plurality of winding portions each of which is formed by winding a conducting wire to one of the teeth portions of the stator core, wherein
each phase from among three phases, includes
a first serial connection section is included in which two or more of the winding portions are serially connected, and
a second serial connection section is included in which two or more of the winding portions are serially connected, and
the first serial connection section and the second serial connection section are connected in parallel, and
when winding portions are viewed from inner periphery side of the yoke portion along a radial direction of the yoke portion, from among the first serial connection section and the second serial connection section,
winding portions included in one serial connection section are formed as a result of winding a conducting wire in one direction, and
winding portions included in other serial connection section are formed as a result of winding a conducting wire in other direction.

15. The three-phase motor according to claim 14, wherein
a first star connection body and a second star connection body are present, each of which includes 3M number of winding portions where M represents an integer equal to or greater than 2, and
winding portions of three phases as included in one star connection body, from among from among the first star connection body and the second star connection body, are formed as a result of performing winding in the one direction, and
winding portions of three phases as included in other star connection body, from among from among the first star connection body and the second star connection body, are formed as a result of performing winding in the other direction.

16. The three-phase motor according to claim 14, wherein
12 of the winding portions are arranged in such a way that the winding portions of each phase are repeated in same order of phases along circumferential direction of the stator core, and
when the 12 winding portions are referred to as a first winding portion to a 12-th winding portion in a sequential manner along circumferential direction of the stator core, the winding portions of one phase include a first winding portion, a fourth winding portion, a seventh winding portion, and a 10-th winding portion.

17. The three-phase motor according to claim 16, wherein
the first winding portion and the fourth winding portion are formed as a result of winding the conducting wire in the one direction,
the seventh winding portion and the 10-th winding portion are formed as a result of winding the conducting wire in the other direction,
a conducting wire that is continuous with the fourth winding portion and a conducting wire that is continuous with the seventh winding portion are connected to power wires, and
a conducting wire that is continuous with the first wiring portion and a conducting wire that is continuous with the 10-th wiring portion are connected to neutral points.

18. The three-phase motor according to claim 16, wherein
the first winding portion and the seventh winding portion are formed as a result of winding the conducting wire in the one direction,
the 10-th winding portion and the fourth winding portion are formed as a result of winding the conducting wire in the other direction,
a conducting wire that is continuous with the seventh winding portion and a conducting wire that is continuous with the 10-th winding portion are connected to power wires, and
a conducting wire that is continuous with the first wiring portion and a conducting wire that is continuous with the fourth wiring portion are connected to neutral points.
